(19) United States
(12) Patent Application Publication
(10) Pub. No.: US 2024/0307894 A1
(43) Pub. Date: Sep. 19, 2024

(54) METHOD AND SYSTEM FOR ACTIVE FLOW RATE AND DROPLET SIZE CONTROL OF VARIABLE-ORIFICE SPRAY NOZZLE

(71) Applicant: NUTECH VENTURES, Lincoln, NE (US)

(72) Inventors: Rodney Rohrer, Firth, NE (US); Joe Luck, Raymond, NE (US); Samuel E. Marx, Lincoln, NE (US)

(21) Appl. No.: 18/609,392

(22) Filed: Mar. 19, 2024

Related U.S. Application Data
(63) Continuation-in-part of application No. PCT/US2022/047019, filed on Oct. 18, 2022.
(60) Provisional application No. 63/256,845, filed on Oct. 18, 2021.

(51) Int. Cl. B05B 1/12; A01C 23/04; A01M 7/00; B05B 1/30

(52) U.S. Cl. CPC B05B 1/12; B05B 1/30; A01C 23/047; A01M 7/0042

(57) ABSTRACT

A variable-orifice spray nozzle system includes at least one variable-orifice spray nozzle including a nozzle body with a flexible nozzle orifice opening and a mechanism that controls the physical size and shape of the orifice opening. An actuator can set and change the position of the orifice control mechanism. A mount attaches to a spray boom. The actuator has a home position. A pressure sensor senses fluid pressure delivered to the nozzle body. A controller can control the actuator to set a requested nozzle flow rate and/or droplet size based upon data from the pressure sensor via positioning of the actuator. The controller tracks the actuator position relative to its home position via open loop control. A weather control system senses weather conditions and is configured to adjust the requested nozzle flow rate and/or droplet size of the controller according to sensed weather conditions.

### PRIORITY CLAIM AND REFERENCE TO RELATED APPLICATION

The application claims priority under 35 U.S.C. § 120 as a continuation-in-part of prior application PCT/US2022/047019, filed Oct. 18, 2022, which application claims priority under 35 U.S.C. § 119 and all applicable statutes and treaties from prior U.S. provisional application Ser. No. 63/256,845 which was filed Oct. 18, 2021.

### STATEMENT OF GOVERNMENT INTEREST

This invention was made with government support under 2017-67021-26250 awarded by the United States Department of Agriculture, National Institute of Food and Agriculture. The government has certain rights in the invention.

### FIELD

Fields of the invention include spray nozzles. The invention concerns control of spray nozzles to achieve independent control of flow rate and droplet size.

### BACKGROUND

Traditional fixed-orifice spray nozzles are selected for flow rate and droplet spectra required for a given application, such as application of pesticides or fertilizer through agricultural sprayers. In conventional systems, flow can be achieved by adjusting system pressure. However, pressure changes can adversely affect spray quality and change droplet size. Other nozzle configurations, such as Pulse Width Modulated (PWM) nozzles or passive variable-orifice designs, are intended to maintain consistent droplet size and spray pattern as flow rate is changed but those too have limitations.

Spray-applied liquid pesticides are an effective part of integrated pest management in modern agriculture. While spray application methods are well developed using the above described fixed and variable-orifice nozzles, significant problems remain with present systems and methods. A significant challenge is spray drift during application where a pesticide is carried by wind to off-target areas. According to EPA estimates, approximately ten percent of agricultural pesticide sprays miss or move from intended application sites and an estimated seventy million pounds of pesticide active ingredient are wasted to drift annually. Drift can cause many problems including harm to off-target crops and vegetation, reduced effectiveness on the target crop, and environmental and economic damage and pollution to sensitive areas.

With conventional sprayer systems, proper nozzle selection is important for achieving the application rate and droplet size specified on the pesticide product label. Traditional fixed orifice nozzles can in some cases operate at more than one droplet size category by adjusting system pressure. However, this will also change the nozzle flow rate (l/min) and, in turn, change the application rate (l/ha). Application rate must then be managed by adjusting travel speed. If the required application rate or droplet size is outside the nozzle's operating envelope, or if the required travel speed becomes impractical, then the physical nozzle tip must be changed, and the system readjusted. For modern sprayers with booms up to 40 meters wide, this could mean changing dozens of nozzle tips, which is not only expensive and time consuming but leads to increased pesticide exposure for the operator. Conventional sprayers can be configured with nozzle body turrets or stackable nozzle bodies to make it easier to change nozzle tips. While this does add convenience, the operator is still required to manually rotate the turret for each nozzle or activate the correct stacked nozzle to make a discrete change in sprayer performance.

Recognizing these problems, Funseth et al. U.S. Pat. No. 8,919,676 describes a rotary manifold connected to multiple standard fixed-orifice nozzles. A drive motor is actuated to switch between nozzles to change application rate on-the-go to compensate for changes in ground speed. This system is mechanically complex, adds significant weight to large sprayer booms, and requires a relatively significant time to rotate to a next nozzle, especially if the next nozzle is not adjacent to the one currently being used. This amount of time does not allow continuous spray application. This system would not facilitate control of droplet size as its intent is to allow change in application rate by changing fixed orifice nozzles. All the nozzle tips installed on the manifold would have to be selected for the same droplet size appropriate for the given pesticide application and all would have to be changed when an application requires a different droplet size. Adjustment of system pressure would also be required to compensate for the change in orifice size when the manifold rotates for each respective nozzle. Fixed orifice nozzles generally operate in a narrow range of pressure to maintain spray quality. For example, changing to a larger nozzle would induce a pressure drop and the system would have to increase pressure to achieve an appropriate flow rate and spray quality for that nozzle.

With regard to PWM actuated nozzles, Giles confirmed experimentally that flow rate and droplet size can be controlled independently. Giles et al, “Digital Control of Flow Rate and Spray Droplet Size from Agricultural Nozzles for Precision Chemical Application,” Precision Agriculture, ASA-CSSA-SSSA. Madison, WI (1996). A drawback of the PWM approach is that it also uses fixed orifice nozzles which have a limited operating range. Flow rate is managed by turning the flow on and off at high frequency with PWM actuated valve, however droplet size is managed by changing the system pressure. Although Giles demonstrated this capability, the operating range was narrow, and spray quality likely deteriorated as pressure was changed to induce change in droplet size. Another disadvantage of the PWM approach is that the flow is not continuous as it is interrupted by the pulsing on/off PWM cycles and requires sufficiently high frequency to provide adequate application coverage. Giles later reported experiments conducted with hydraulic atomizers. Giles, D. K., “Independent Control of Liquid Flow Rate and Spray Droplet Size From Hydraulic Atomizers. Atomization and Sprays. Vol. 7. pp. 161-181 (1997). This described system also used fixed orifice nozzles and relied on pressure and PWM for altering flow rate or droplet size. In commercial PWM solution, low duty cycle operation is generally not employed due to spray pattern deterioration, particularly at lower pressures.

In contrast to fixed-orifice nozzles, a variable-orifice nozzle can decouple pressure and flow in the sense that the same flow rate can be achieved at various system pressures by changing the orifice size. This can enable a wider range of flow rates and droplet spectra for a single nozzle tip.

A variable-orifice nozzle modified by Luck et al. for active control can span multiple droplet spectra and offers independent control of flow and droplet size. See, Luck et al., “Flow, Spray Pattern, and Droplet Spectra Characteristics of an Electronically Actuated Variable-Orifice Nozzle,” Transactions of the ASABE, v. 58, issue 2, p. 261-269 (2015). This study evaluated the flow rate, spray pattern, and droplet spectra characteristics of an actively controlled variable-orifice nozzle at constant carrier pressures. The testing was conducted with a commercially available variable-orifice nozzle (VariTarget) that was modified to allow for direct electromechanical control of the metering stem. The Luck variable-orifice nozzle provided an electronically controlled nozzle capable of varying droplet size and flow rate independently, and continuously, across several droplet size spectra using a single nozzle tip. Luck (2012) found that modifying a seal between the nozzle tip and the VariTarget nozzle body, by removing the inner ‘collar’ of the seal, increased the range of flow through the nozzle. Luck mapped flow rate, system pressure, effective orifice size, and droplet size for a green (coarse) VariTarget nozzle tip. The system was not integrated with automated control. Operation was demonstrated by manually adjusting system pressure and nozzle actuator position to produce droplet sizes across several droplet spectra with a single spray tip.

Kocer and Michael US Published Application No. US2019/0350187 describes a configurable nozzle assembly. A nozzle body in the assembly includes a plate or plates that change the physical size and/or shape of an opening that communicates fluid to the nozzle orifice. The movement of the plates or plate can be controlled by an actuator. The sliding or rotating plates a very small pieces, scaled for a practical nozzle at about ¼ inch in diameter for the rotating plate. The precision and reliability of adjustment of such small pieces is questionable for a commercial spray boom. The configurable nozzle uses sensor feedback to facilitate maintenance of a desired spray pattern as well as a specified droplet size when pressure and/or flow change.

### SUMMARY OF THE INVENTION

A preferred embodiment provides a variable-orifice spray nozzle system includes at least one variable-orifice spray nozzle including a nozzle body with a flexible nozzle orifice opening and a mechanism that physically alters the shape and size of the nozzle orifice opening. An actuator can set and change the position of the orifice control mechanism. A mount attaches to a spray boom. The actuator has a home position. A pressure sensor senses fluid pressure delivered to the nozzle body. A controller can control the actuator to set a requested nozzle flow rate and/or droplet size based upon data from the pressure sensor via positioning of the actuator. The controller tracks the actuator position relative to its home position via open loop control. A preferred weather control system senses weather conditions and is configured to adjust the requested nozzle flow rate and/or droplet size of the controller according to sensed weather conditions.

### BRIEF DESCRIPTION OF THE DRAWINGS

FIGS. 1A-1B are respectively is a cross-sectional view of a preferred variable orifice valve assembly for a sprayer control system with its actuator in a home position and a partial view of the orifice control in a partially closed position;

FIGS. 2A and 2B are images of a prototype nozzle assembly according to FIG. 1;

FIG. 3 shows a screen of a preferred Field Programmable Gate Array (FGPA) user interface for a sprayer control system and method of the invention;

FIG. 4 shows a screen of a preferred real-time (RT) system user interface for a sprayer control system and method of the invention;

FIG. 5 shows a screen of a preferred user interface front panel for a sprayer control system and method of the invention;

FIG. 6 is a diagram illustrating preferred service and calibration software logic for a sprayer control system and method of the invention;

FIGS. 7A, 7B and 7C respectively show data of recorded pressure, flow, and commanded actuator position for each nozzle from an experimental sprayer control system and method of the invention;

FIG. 8 is a scatter plot of mean steady-state operating point values from an experimental sprayer control system and method of the invention;

FIG. 9 is a cross-sectional view of a preferred variable orifice valve assembly nozzle illustrating a relationship between metering stem position and orifice size;

FIG. 10 is simulation data showing a linear regression of 25 mean pressure, actuator position, and flow values for a preferred variable orifice valve;

FIG. 11 is simulation data showing a linear regression of 25 mean pressure, actuator position, and volume mean diameter values for a preferred variable orifice valve;

FIG. 12 shows Real Time layer front panel from an experimental variable orifice valve system displaying constants read from a calibration file and nozzle characteristics loaded from a parameter file;

FIG. 13 shows a user interface front panel control from an experimental variable orifice valve system illustrating a nozzle type selector, droplet spectra selector, selection complete button, system controls, system feedback, and graph of system model;

FIG. 14 shows a user set-up screen from an experimental variable orifice valve system;

FIG. 15 a diagram illustrating preferred field program software logic for a sprayer control system and method of the invention;

FIGS. 16A, 16B, 17A and 17B show experimental data of simulated curve fit polynomials applied to the flow data from an experimental variable orifice valve assembly;

FIGS. 18 and 19 show flow error data comparing expected pressure to an experimental variable orifice valve assembly;

FIG. 20 is a block diagram of a preferred weather control system that adjust the requested nozzle flow rate and/or droplet size of the FIG. 1 and FIGS. 2A-2B sprayer control system;

FIG. 21 shows testing data of an experimental weather control system showing Desired vs. Arbitrated Dv10 Droplet Size taken at a 30% Relative Humidity without changing wind speed;

FIG. 22 shows testing data of an experimental weather control system showing Desired vs. Arbitrated Dv10 Droplet Size taken at a 30% Relative Humidity without changing flow;

FIG. 23 shows testing data of an experimental weather control system showing Desired vs. Arbitrated Dv10 Droplet Size taken at a 10% Relative Humidity with changing Wind Speed and Flow values; and

FIG. 24 shows testing data of an experimental weather control system showing Desired vs. Arbitrated Dv10 Droplet Size taken at a 60% Relative Humidity with higher Wind Speed and Flow values than allowed by standard irrigation practices.

### DETAILED DESCRIPTION OF THE PREFERRED EMBODIMENTS

A preferred embodiment provides a sprayer control system for a variable-orifice nozzle that that can effectively and simultaneously manage: flow rate, pressure, effective orifice size, and droplet size.

Preferred systems provide open-loop control logic that manages four system variables: flow rate, pressure, droplet size, and effective orifice size. The control system can automatically target desired droplet spectra and flow rate by adjusting pressure and effective orifice size. Preferred systems provide adaptable control methods that provide ability for site-specific droplet size control, weather-based droplet size control, and are well suited for robotic and autonomous spray systems.

Performance characteristics of five sizes of variable-orifice nozzles (red—very fine, orange-fine, yellow-medium, blue-coarse, green-very coarse) were evaluated in a prototype system, which showed that two nozzles (blue and green), spanning fine to very coarse droplet spectra, could replace four or five conventional nozzles. Validation tests confirmed the control method could independently vary flow rate and droplet size. Droplet volume mean diameter was within ±10% of desired size for all operating points. Actual flow rate was within ±10% of desired flow at nearly all operating points above 207 kPa. Optimization of the control method showed an ability to reduce flow error to less than ±10% across the entire operating envelope. Testing and simulation showed that changes in flow and droplet size are also continuous, with no discrete step changes in performance as would be experienced when changing fixed-orifice nozzle tips. Performance of the variable-orifice nozzle system showed that the variables can be controlled to achieve a desired application rate (I/ha) and a desired droplet size for a given pesticide or fertilizer.

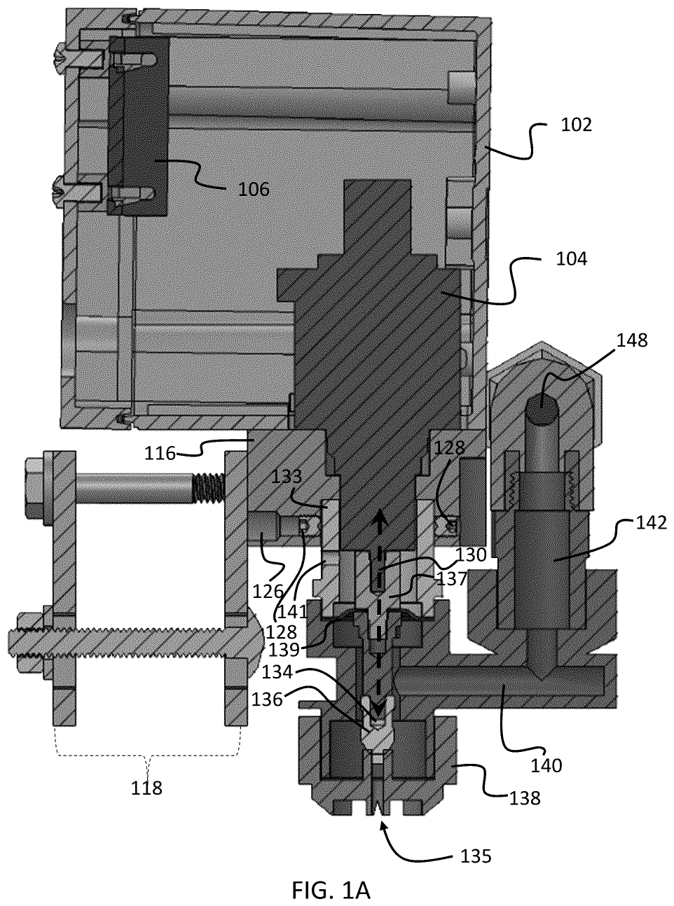

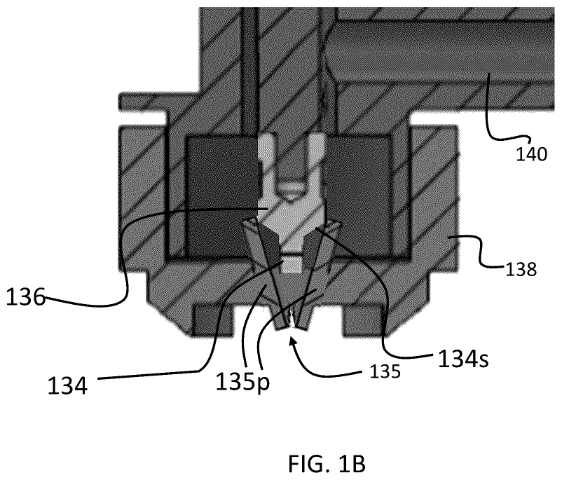

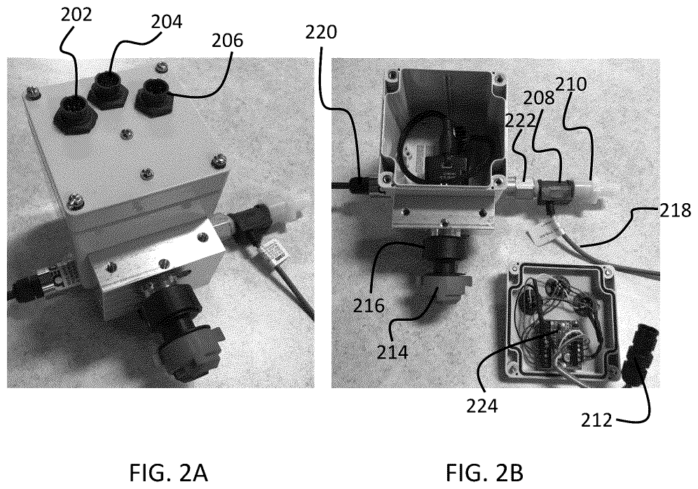

Parts List for FIGS. 1 and 2A-2B. The following parts are shown in FIGS. 1 and 2A-2B. The list that follows introduces the parts and their basic function.

| Reference Number | Part Name | Part Function |
|---|---|---|
| 102 | Enclosure | Electronic components weather-proof |
| | | enclosure |
| 104 | Linear actuator | Stepper motor/linear actuator for controlling |
| | | orifice size |
| 106 | Motor driver | Electronic control board for linear actuator |
| | | motor control |
| 116 | Nozzle mounting | Allow nozzle to be mounted to boom/heat sink |
| | block/heat sink | |
| 118 | Boom mounting | Clamp enclosure/nozzle system to spray boom |
| | brackets | |
| 126 | Set screw access | Drilled hole for tightening set screws |
| 128 | Set screw | Provides connection between block and adapter |
| | | cylinder |
| 130 | Linear actuator | Allows metering stem extension adapter to be |
| | threaded rod | threaded (i.e., connected) to linear actuator |
| 133 | Adapter cylinder | Allows nozzle block to be clamped to nozzle |
| | | body thus sealing the rubber diaphragm 139 |
| 134 | Metering stem | Connects metering stem extension adapter 137 |
| | | to metering tip 135 and moves up and down |
| | | with actuator 104 |
| 135 | Flexible size and | Flexible shaped and sized opening that fluid |
| | shape orifice opening | leaves from. |
| | from nozzle orifice | |
| | 136 | |
| 136 | Nozzle orifice | Exit orifice for spray mixture (enables droplet |
| | | size + flow rate control) |
| 137 | Metering stem | Allows linear actuator 104 to be connected to |
| | extension adapter | metering stem 134 |
| 138 | Variable orifice nozzle | Body of exit orifice for spray mixture (enables |
| | cap flexible body | droplet size + flow rate control) |
| 139 | Rubber diaphragm | Creates seal between system fluid and linear |
| | | actuator |
| 140 | Nozzle body fluid | Allows fluid flow from boom distribution to |
| | chamber | nozzle body |
| 141 | Adapter cylinder weep | Allows water to drain from adapter cylinder in |
| | hole | case of rubber diaphragm failure |
| 142 | Nozzle body fluid | Allows fluid flow from boom distribution to |
| | chamber | nozzle body |
| 148 | Nozzle body fluid feed | Fluid flow feed from boom distribution to |
| | | nozzle body |
| 202 | connector | Connector for pressure sensor power and signal |
| 204 | connector | Connector for actuator power and control |
| | | signals |
| 206 | connector | Connector for flow meter power and signal |
| 208 | Flow meter | Measures fluid flow into individual variable |
| | | orifice nozzle |
| 210 | Fluid supply line | Allows connection for fluid flow from boom to |
| | | nozzle |
| 212 | Electrical connector | Allows connection between motor controller |
| | | and linear actuator |
| 214 (136) | Variable orifice nozzle | Exit orifice for spray mixture (enables droplet |
| | | size + flow rate control) |
| 216 | Nozzle body | Connects nozzle orifice to boom for fluid flow |
| 218 | Flow meter cable | Electrical connector for flow meter |
| | | power/signal cables |
| 220 | Pressure sensor | Measures pressure for input into controller |
| 222 | Check valve | Prevents fluid from draining from nozzle when |
| | | fluid system is not pressurized |
| 224 (106) | Motor driver | Electronic control board for linear actuator |
| | | motor control |

A preferred variable orifice valve assembly for a present sprayer control system including the above parts is shown in FIGS. 1A-1B and 2A-2B. The assembly includes variable-orifice spray nozzle 138, 214 including a flexible nozzle cap body 138 and a mechanism 104, 130, 134, 136, 137 that controls effective size of a flexible nozzle orifice opening 135 an actuator 104,130 to set and change the position of the orifice control mechanism 137,134,136, and a mount to attach to a spray boom 118. The mechanism 104, 130, 134, 136, 137 moves vertically to control the physical size and shape of orifice opening 135, which advantageously provides for reliable operation with simple and repeatable movement up and down of the metering stem 134 into the orifice opening 135 to change its shape, as shown in FIG. 1B, wherein the orifice opening 135 is shown with the metering stem inserted to change the physical size and shape of the orifice opening 135. Specifically, two flexible portions 135p are forced apart by a sloped shoulder 134s of the metering stem 134 to create the physical size and shape change in the orifice opening 135.

In FIGS. 2A and 2B, an electrical connection 212 to the actuator is shown. A supply 210, 148 with pressure control to supply fluid to the at least one variable-orifice spray nozzle and a pressure control connection 210 to the pressure control; and a controller 106,224 interfaced to the electrical connection 202,204,206 and the pressure control connection 210. Overall system pressure can also be controlled such that pressure to the fluid feed 148 is controllable. Such system pressure control is possible, for example, by 1) an electronic/motorized control bypass valve or 2) direct pump speed control. In experimental systems of the invention, pump speed was controlled to maintain desired system pressure. The experimental system demonstrated control of system pressure in conjunction with the effective orifice size.

The assembly is a modified version of the Luck (2012) assembly. The same stepper motor linear actuator 104,130 (Zaber NA1416A, Zaber Technologies, Vancouver, BC) was used in place of the factory installed spring in the VariTarget nozzle body 216 (138, 140) to allow active control of the internal metering stem 134. The linear actuator 104, 130 had a range of 16 mm with 200 steps per revolution and 1.2192 mm per revolution. The motor driver 224, 106 and actuator 104,130 allows for micro-stepping, but micro-stepping is not necessary. The linear actuator 104,130 included an integral Hall-effect sensor that was used to detect when the actuator 104,130 was fully retracted to its home position, which position is illustrated in FIG. 1. An activated position is shown in the partial view of FIG. 1B, with the metering stem 134 having been moved downward to limit flow from the nozzle body chamber 140 and thereby control the effective size of the nozzle orifice 136. The physical design of the nozzle body 216 (138,140) and adapter block 116 in a prototype required that the metering stem 134 be limited to no more than approximately 750 steps to prevent damaging the spray tip 138, 214 by pushing the metering tip 136 too far into the nozzle 138, 214.

The metering stem extension adapter 137 metering stem 134, adapter cylinder 133 and internal features of the adapter block 116 were sized to have with a length tolerance to ensure consistent metering tip 136 displacement among different nozzle assemblies. The assembly added two soft joints that caused some variation in the tolerance stack-up. The soft joints occurred where a rubber diaphragm 139 was installed to allow the metering stem 134 to move while sealing fluid from leaking to the top of the nozzle body 216 and flooding the linear actuator 104,130. The linear actuator has a range of vertical movement to allow its tip extension 130, metering stem extension adapter 137, and the metering stem 134 to move up and down as shown to modify the nozzle orifice 136. Note the rubber diaphragm 139 also deforms due to this motion. A weep hole 141 was added to the adapter cylinder 133 to allow fluid to drain externally in the event of leakage past the diaphragm 139. The nozzle adapter block 116 was drilled and tapped to allow a threaded bolt to clamp the boom mounting brackets such that the nozzles could be attached to a spray boom and to attach an enclosure 102 to protect the stepper motor 104,130 and motor driver 106, 224.

FIGS. 2A and 2B show images of a prototype nozzle assembly according to FIG. 1. Pressure sensors 220 (PX09-100G5V, Omega Engineering Inc., Norwalk, CT) and turbine flow meters 208 (FTB-430, Omega Engineering Inc., Norwalk, CT) were installed on each nozzle assembly. The pressure sensors 220 had a range of 0 to 689 kPa with 0 to 5 volt output. The flow meters 208 had a range of 0.76 to 7.57 liters per minute with an output of 34 to 343 Hz. While only one pressure sensor 220 is required for operation because pressure is typically uniform across a spray boom, pressure sensors 220 were included in each nozzle assembly for collection of experimental data. Data from these sensors were logged during control system development to understand variation in performance of the nozzle assemblies. Flow meters 208 were installed on each nozzle assembly to provide a data for characterizing nozzle performance and are not required in a practical system of the invention. A 21 kPa check valve 222 (SM650-6F6FB check valve, Dultmeier Sales, Omaha, NE) was included to prevent fluid from draining when the system was turned off. The seal between the VariTarget nozzle body 138, 216, 140 and spray tip 138 was modified by removing the inner ‘collar’ of the seal in the same manner as done by Luck (2012) to increase the operating range of the variable-orifice nozzle 135,138,214.

The controller in the prototype system was a National Instruments (NI) compact reconfigurable input output (cRIO) embedded controller (cRIO-9068, National Instruments, Austin, TX) with Field Programmable Gate Array (FPGA) and Real-Time (RT) processor. The cRIO controller was configured with one NI 9403 32-channel TTL digital IO module and one NI 9205 32-channel 16-bit analog input module (National Instruments, Austin, TX). The stepper motor linear actuators were interfaced with the controller using Big Easy Driver stepper motor drivers 106, 224 (SparkFun Electronics, Niwot, CO). Although the motor drivers allowed micro-stepping, they were configured to use only a full step for each digital pulse generated by the controller. Motor driver current limits were adjusted to rated motor current of 0.57 amps. Each motor driver used three channels from the NI 9403 module, one each for stepping, direction, and home signal, with one additional digital channel for each flowmeter. Each pressure sensor used one analog channel on the NI 9205 module.

The temperature of the linear actuators can rise too much when the stepper motors are powered continuously, even when no motion is commanded. The motor drivers include a feature where they can be disabled with a digital signal to minimize power consumption and reduce heat build-up in the linear actuators when not in motion. However, we determined that if the actuators were not continuously powered, they could be back-driven by the fluid pressure acting on the diaphragm in the nozzle assembly and would not be able to hold their position when under load. A thermocouple was installed in one of the nozzle assemblies to evaluate temperature rise of a continuously powered actuator. When the nozzle assembly was not installed on the metal spray boom, and with no fluid flowing through the nozzle, the temperature rose to 63 degrees Celsius and was still rising slightly when the evaluation was stopped. When mounted to the metal spray boom, the temperature stabilized at approximately 49 degrees Celsius when no fluid was flowing through the nozzle and at approximately 35 degrees Celsius when fluid was flowing. The linear actuator manufacturer confirmed the need to leave the actuators powered to better hold their position. We determined that a solution is to include the heat sink 116 in the assembly to manage temperature/limit heating. Experiments show that a spray boom will itself act as a heat sink. Other heat sinks can be added, and typical heat transfer strategies can also be used, e.g., including cooling fin structures on the nozzle body or on the spray boom.

In the prototype system, LabVIEW software (National Instruments, Austin, TX) along with LabVIEW Real-Time Module and LabVIEW FPGA Module were used to operate the NI cRIO-9068 embedded controller. Commercial systems can allow the embedded controller to run as a headless system, i.e., as an embedded system with no external computer or user interface. The testing required a user interface on a connected PC to allow the user to perform sensor calibrations and manually command actuator positions. A service and calibration program was created which consisted of three software layers: FPGA, RT, and user interface (UI) on the host PC.

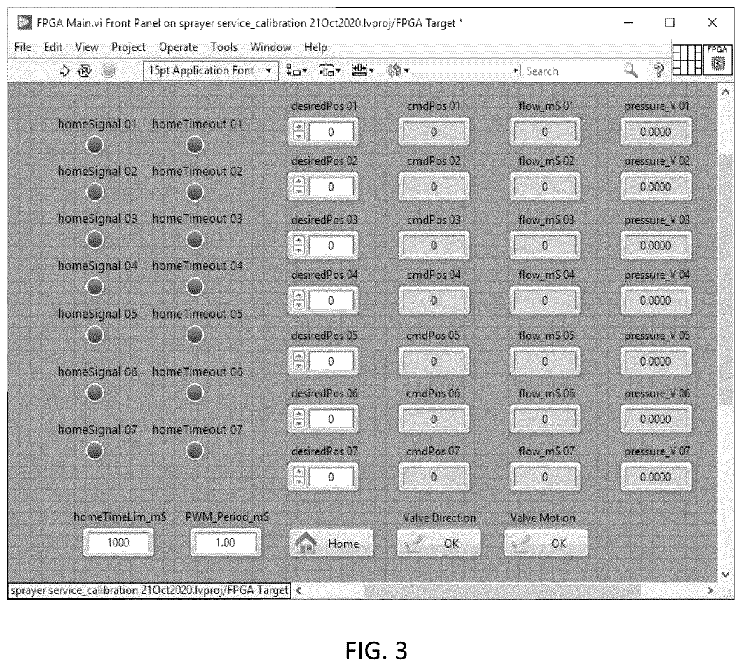

FIG. 3A shows a screen of the interface with the actuators and sensors, specifically the FPGA front panel. It was in this software layer that analog voltage from the pressure sensors was sampled and passed directly to the RT software layer. In a separate FPGA processing loop, the period between flow meter pulses was measured by monitoring changes in the rising edge of each flow meter's digital input. With each new rising edge detected, elapsed time from the previous rising was determined.

A processing loop in the FPGA software contained the basic logic for controlling the linear actuators. This involved two digital outputs, for direction and step, and one digital input for home position. If home position was detected then no step command was given, actual position was set to zero, and direction was set to extend; the actuator would stop and remain in standby mode in its fully retracted position. If actuator motion was commanded, the program would determine the position error, in units of motor steps, between current position and desired position. Direction was determined by the sign of the error, if desired position minus actual position was positive then direction was set to extend, if negative, retract. Actuator motion was accomplished by sending a digital pulse to the motor driver for each step until position error was zero. The period of the pulse train could be adjusted with a value sent from the RT software layer. Various values were evaluated down to one millisecond (ms) per step where the actuators were able to reach the desired position quickly, accurately, and consistently.

Although the actuators included a Hall-effect sensor that provided an indication of fully retracted, or home, position, no other feedback was available to indicate actual position when extended away from home position. Due to the deterministic nature of a stepper motor, it was possible to accurately position the actuators with open-loop control, i.e., with no position feedback, by counting motor steps. With each loop executed in the FPGA software, the program checked the status of the home signal and, if not fully retracted, calculated position, set direction, generated a pulse for each step, and counted ascending or descending steps to maintain a record of actual position.

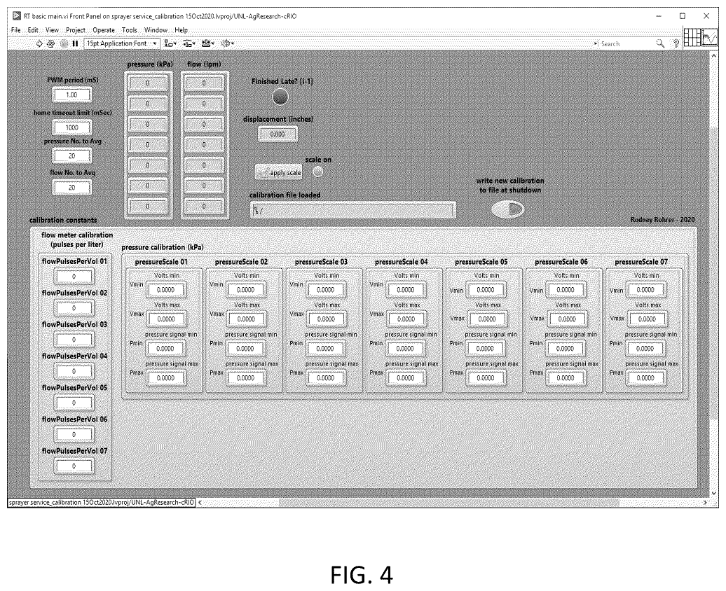

FIG. 4 shows the real-time (RT) system interface of the prototype system. This layer contained the logic to send actuator commands to the FPGA, retrieve sensor values from the FPGA, filter sensor signals, scale sensor values to engineering units, record sensor values and actuator status to a log file, read and write sensor calibration files, and send information to and from the UI on the host PC. It is worth noting again, that preferred systems included open-loop control of flow rate and require no flow sensors or flow sensor feedback. The purpose of flow sensors and feedback was solely to acquire data for testing the prototype system. A producer-consumer architecture was used in the RT software to allow multiple processing loops to share data while running at different rates. In this way, high priority and time critical tasks could run in the high-speed producer loop which produces data and sends it to the slower consumer loop via a queue. The consumer loop processed data that it consumed from the queue and handled lower priority tasks that were not time critical.

The producer loop was a timed loop that sent and received information from the FPGA at a frequency of 20 Hz. Signals sent to the FPGA include desired actuator position (steps), period of motor step pulses (ms), home sensor timeout limit (ms), and home button command. These values were used in the FPGA software processes described above. Pressure sensor voltage and flow meter period (ms/pulse) received from the FPGA were smoothed with a moving average filter before being scaled to engineering units. The number of samples to filter was programmed as a configurable input from the RT front panel. A variety of values were evaluated and a twenty-point moving average was found to offer adequate smoothing of the pressure and flow signals without creating excessive delay in their response, effectively resulting in a one-second moving average filter.

Sensor calibration constants were read from an extensible markup language (xml) file and were used to scale raw sensor values to engineering units. The RT software included provisions to toggle the scale on/off as needed depending on the current activity. In calibration mode, the scales would be turned off so raw sensor values were recorded in the log file. These data could be post processed along with the corresponding known applied pressure or flow to create the calibration scale values. The calibration constants were input into the RT front panel and could be written to a new, unique xml calibration file. Each time the program started it automatically loaded the newest calibration file. In this way the program was set up to maintain the best practice of avoiding hard-coding calibration values in the software.

The consumer loop in the RT software received information from the producer loop via a queue and recorded it to a log file in National Instruments Technical Data Management Streaming (tdms) format. The log file included four channels for each nozzle (measured pressure, measured flow, desired position, and commanded position) along with operator name, test description, units for data channels, sample rate, and other metadata.

The final function of the RT software was to communicate with the UI software layer on the host PC. Information sent from the RT layer to the UI included filtered and scaled pressure and flow signals, commanded actuator position, home position status, and home timeout status for each nozzle. Information received from the UI included desired actuator position(s), command from the home button, and metadata to be included in the log file (e.g., log file name, operator name, description, etc.).

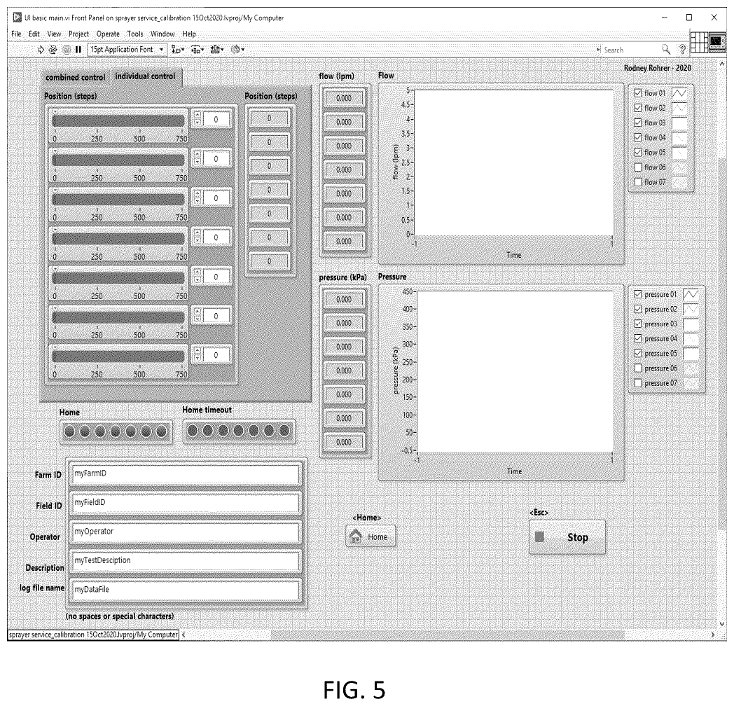

FIG. 5 shows the user interface front panel. The UI allowed the operator to input desired actuator position(s) individually or as a single command to move all actuators simultaneously. The operator could also actuate a home button that would return all actuators from their current position to their fully retracted home position. These operator commands were sent to the RT layer along with the log file metadata described above.

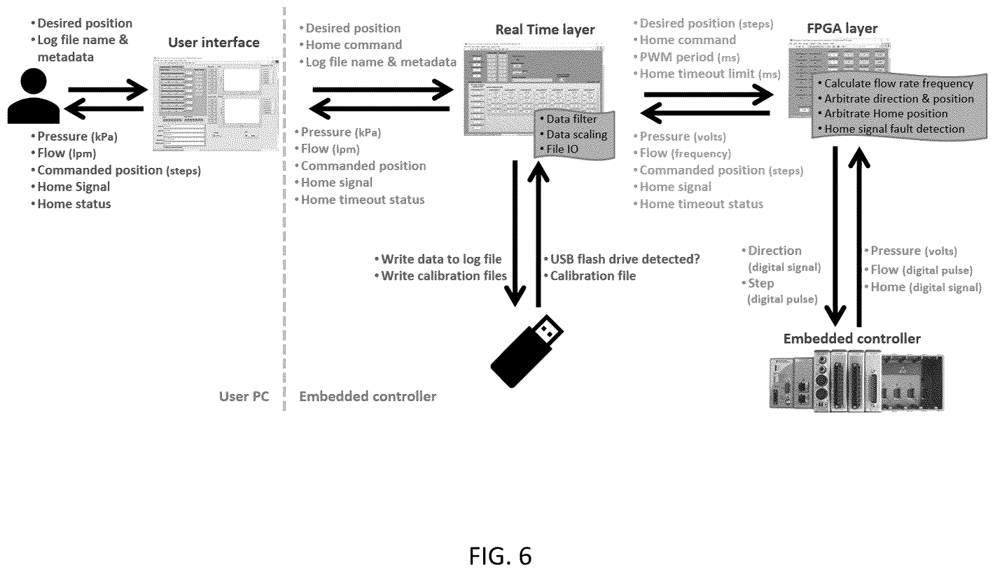

Service and calibration software logic is shown in FIG. 6. The UI received information from the RT layer which allowed the operator to monitor filtered and scaled pressure and flow signals. Actuator position, home status, and home timeout signals were also displayed for each nozzle.

The open-loop control strategy for actuator positioning was verified to provide accurate and repeatable displacement of the nozzle metering tip. To measure actuator displacement, a dial indicator (Starrett No. 650, L.S. Starrett Co., Athol, MA) was attached to the nozzle assembly with the plunger opposed to the end of the metering stem extension. The dial indicator had a resolution of 25.4 micrometers (μm); which, with actuator resolution of 6.1 μm per step, is equivalent to 4.2 motor steps.

Each actuator was returned to its home position, and the dial indicator zeroed, before commanding the actuator to move a given number of steps. Displacement was read from the dial indicator as the actuator position was increased and then decreased. Measurements were compared to the expected displacement to determine positioning error and hysteresis. Maximum error observed was 2.1% and largest hysteresis was 25.4 μm, or less, as this is the resolution of the dial indicator. It was discovered that the metering stem in some of the nozzle assemblies could bottom-out inside the nozzle bodies just before reaching 800 steps. Because of this, the operating range was reduced to 750 step maximum.

For testing of the control system, a five-nozzle spray system was created based on the variable-orifice nozzle described above. It was tested with the software and sensors described above. A preferred control system was developed and is described next. The preferred control system can enable a wide range of flow rates and droplet spectra for a single nozzle tip. Changes in flow and droplet size are also continuous, with no discrete step changes in performance as would be experienced when changing fixed-orifice nozzle tips or using conventional systems described in the background.

Performance of the variable-orifice nozzle system uses four variables: system pressure, actuator position (i.e., effective orifice size), droplet size, and flow rate. These variables can be controlled to achieve a desired application rate (l/ha) and a desired droplet size for a given pesticide or fertilizer.

The control system is driven by a mathematical model which was derived by performing a curve fit, or regression, to get a best fit polynomial equation. The regression equation describing the relationship of the nozzle parameters was then used to devise a method to actively control a variable-orifice nozzle. In this case, two regressions were completed to create two equations which modelled the variable-orifice nozzle performance. The first was a linear regression of pressure and actuator position on flow, the second was of pressure and actuator position on volume mean diameter (i.e., droplet size).

Control can be conducted with the following set of two equations with four unknowns:

$$Q = a + b ⋆ P + c ⋆ M \qquad Equation 1.1$$

$$VMD = d + e ⋆ P + f ⋆ M \qquad Equation 1.2$$

Where, Q=flow rate (lpm)
VMD=droplet volume mean diameter (μm)
P=pressure (kPa)
M=effective orifice size
a, b, c, d, e, f=polynomial coefficients

One of the four unknowns, droplet size (VMD), can be specified directly by the operator or input from an additional control algorithm based on wind speed or other relevant parameters. A second unknown, nozzle flow rate (Q), can be determined from information provided by the operator: application rate (l/ha), nozzle spacing, and desired steady-state ground speed. Ground speed could also be an input from GPS, radar, or other ground speed sensor, or from a geospatial prescription map. With application rate, nozzle spacing, and ground speed known, required nozzle flow rate can be determined from equation 1.3:

$$Q = rate ⋆ \frac{speed}{600} ⋆ nozzle spacing \qquad Equation 1.3$$

rate=application rate (l/ha)
speed=ground speed (kph)
nozzle spacing (m)

With droplet size specified and nozzle flow rate determined from operator inputs, two of the four variables were known and the remaining two, pressure (P) and actuator position (M) (i.e., effective orifice size), were found by solving equations 1.1 and 1.2 simultaneously to yield equations 1.4 and 1.5.

$$P = \frac{( Q - a ) ⋆ f + ( d - VMD ) ⋆ c}{b ⋆ f - c ⋆ e} \qquad Equation 1.4$$

$$M = \frac{( VMD - d ) ⋆ b + ( a - Q ) ⋆ e}{b ⋆ f - c ⋆ e} \qquad Equation 1.5$$

With these two equations, the control system could solve for the pressure and actuator position required to achieve the rate and droplet size desired by the operator.

Nozzle assemblies were installed on a test bench where each of five blue and five green nozzles were operated at 25 steady-state operating points. These observations spanned the nozzle operating envelope with five pressures, every 69 kPa from 138 to 414 kPa, at each of five actuator positions, every 100 motor steps from 400 to 700 steps and at 750 steps.

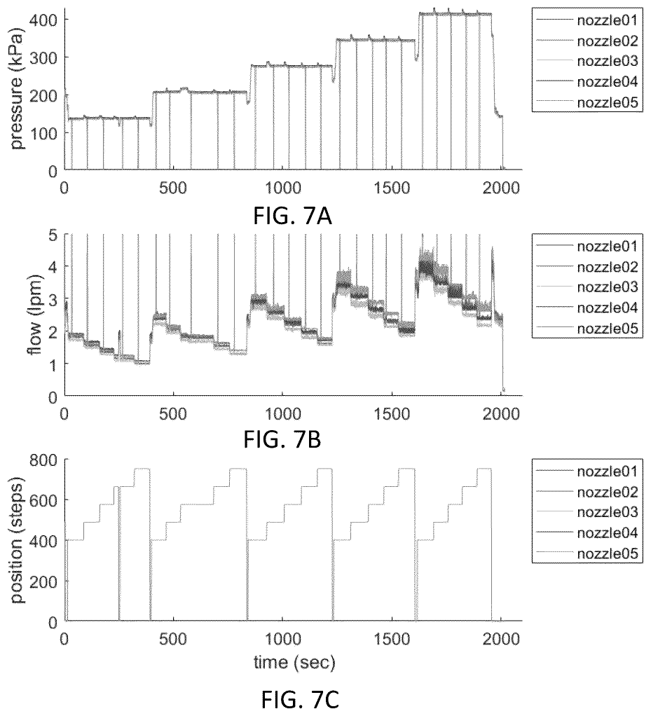

FIGS. 7A, 7B and 7C respectively show data collected from five “blue” nozzle caps operated at 25 steady-state operating points. These observations spanned the nozzle operating envelope with five pressures, every 69 kPa from 138 to 414 kPa, at each of five actuator positions, every 100 motor steps from 400 to 700 steps and at 750 steps. The data shows recorded pressure, flow, and commanded actuator position for each nozzle at the previously mentioned operating points

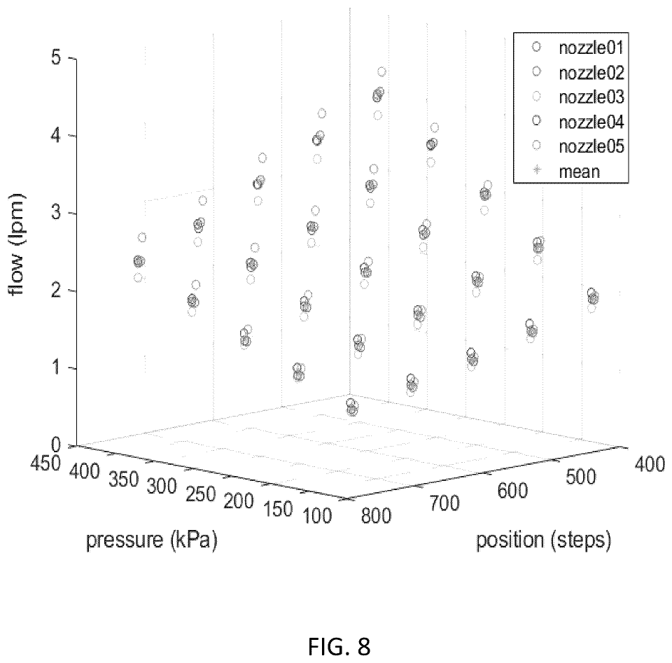

FIG. 8 is a scatter plot of mean steady-state operating point values. This data shows the resulting flow rate for multiple nozzles tested at different pressure and orifice sizes (i.e., ‘position (steps)’) for the system.

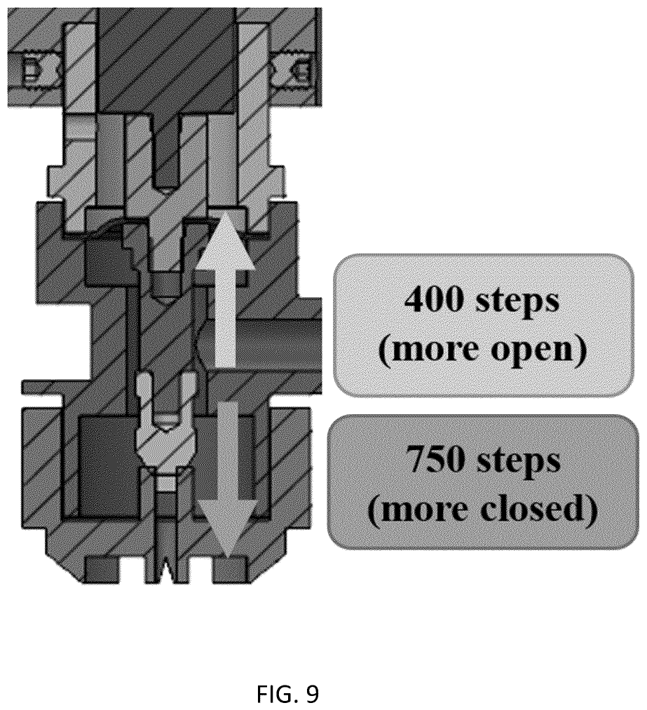

FIG. 9 shows a nozzle and the relationship between metering stem position and orifice size. This data shows that a lower value of motor steps (e.g., 400 more open) retracts the metering stem from the nozzle orifice, thus increasing orifice size. A greater value of motor steps (e.g., 750 more closed) moves the metering stem toward the nozzle orifice, thus decreasing orifice size.

An observation from the time-series data was that more flow variation existed at operating points with high pressure and low metering stem positions. This flow instability is believed to be the result of the spray tip being less supported when the metering stem was less engaged in the spray tip and was accentuated with high flow rates induced by high pressure.

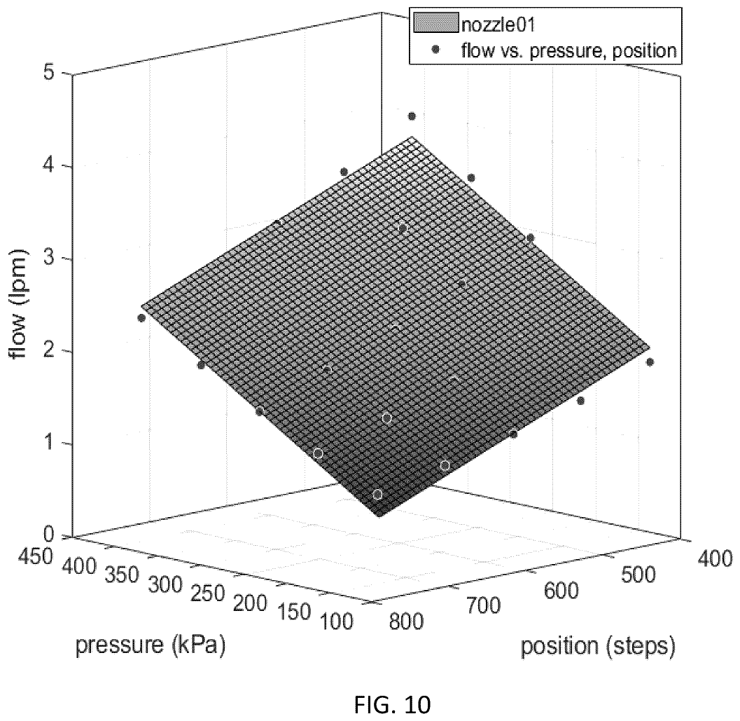

FIG. 10 shows a linear regression was done on the 25 mean pressure, actuator position, and flow values for each nozzle with Matlab R2020a. This data shows the range of flow rate values the system can generate at the different combinations of pressure and orifice settings (‘position (steps)’).

TABLE A
Polynomial coefficients, coefficient of determination,
and root mean square error for regression of
pressure and actuator position on flow.

| | | polynomial coefficients | | | | |
|---|---|---|---|---|---|---|
| | | a | b | c | R² | RMSE |
| blue | nozzle01 | 2.5647 | 0.0062 | −0.0035 | 0.983 | 0.105 |
| | nozzle02 | 2.5526 | 0.0065 | −0.0036 | 0.984 | 0.105 |
| | nozzle03 | 2.3944 | 0.0057 | −0.0033 | 0.979 | 0.108 |
| | nozzle04 | 2.6312 | 0.0059 | −0.0034 | 0.984 | 0.097 |
| | nozzle05 | 2.4283 | 0.0074 | −0.0035 | 0.985 | 0.108 |
| | mean | 2.5136 | 0.0064 | −0.0035 | 0.984 | 0.104 |
| green | nozzle01 | 3.5099 | 0.0078 | −0.0046 | 0.987 | 0.119 |
| | nozzle02 | 3.4464 | 0.0074 | −0.0045 | 0.987 | 0.112 |
| | nozzle03 | 3.3714 | 0.0077 | −0.0045 | 0.987 | 0.114 |
| | nozzle04 | 3.4781 | 0.0079 | −0.0045 | 0.984 | 0.130 |
| | nozzle05 | 3.5650 | 0.0081 | −0.0045 | 0.987 | 0.120 |
| | mean | 3.4741 | 0.0078 | −0.0045 | 0.987 | 0.118 |

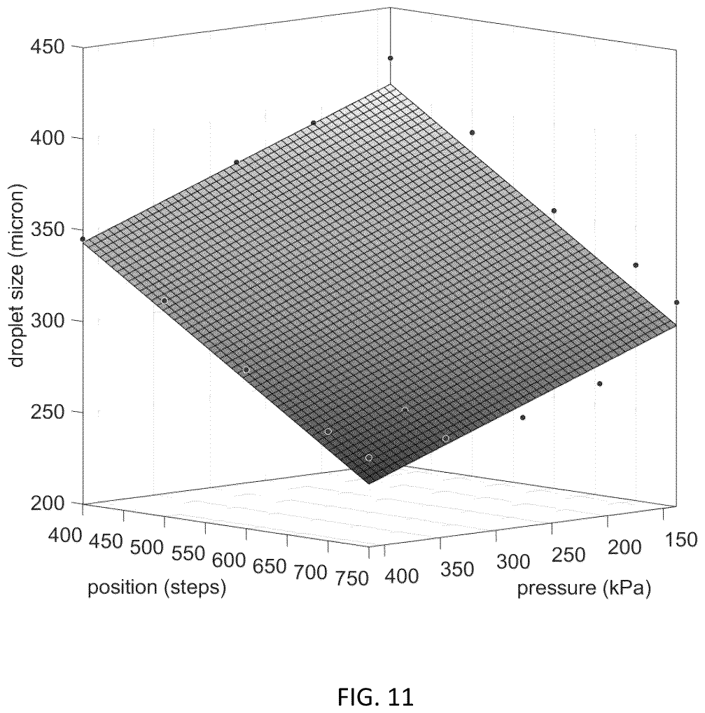

Linear regression was also performed on 25 mean pressure, actuator position, and volume mean diameter (VMD) values measured at the PAT Lab for one blue and one green nozzle (FIG. 11). Polynomial coefficients, coefficient of determination, and root mean square error for the regression are in table B. This data shows the range of droplet sizes (VMD) the system can generate at the different combinations of pressure and orifice settings (‘position (steps)’).

TABLE B

| | | polynomial coefficients | | | | |
|---|---|---|---|---|---|---|
| | | d | e | f | R² | RMSE |
| blue | nozzle01 | 564 | −0.2348 | −0.3099 | 0.96 | 10.03 |
| green | nozzle01 | 653 | −0.4014 | −0.3069 | 0.95 | 13.16 |

For realistic testing, a field program was created with LabVIEW software that incorporated the nozzle control algorithm described above to automate actuator positioning and determine system pressure required to achieve the application rate and droplet spectra specified by the operator.

The field program had a similar architecture to that of the service and calibration program but provided additional features in the RT and UI layers. The FPGA layer was identical to that described above and performed the same low level actuator control and sampling of sensor signals. The RT layer had the same interaction with the FPGA layer as that of the service and calibration software but included other features to facilitate the automated nozzle control.

The RT software for the field program was deployed on the embedded controller and configured to run on startup. In this way, when the controller was powered, or reset, the RT software would start automatically and execute an initialization sequence before waiting in a standby mode for operator inputs.

If the controller were to lose power during operation, positions of the actuators would be unknown at the next startup. For the open-loop control to properly position the actuators their position had to be accurately known. Additionally, if the actuators were commanded to extend from an already extended, but unknown, position, it may have been possible to for them to overextend and potentially damage the nozzle tips. To reset the actuators to a known position all actuators were returned to home position at startup. This was accomplished by an initialization sequence where, if any home signals were false, all actuators were commanded to retract. Next, all actuators were commanded to extend to 400 steps so that they were past the hysteresis band of the hall-effect sensors. Finally, the actuators were once again fully retracted to their home positions before the program would standby to wait for information from the UI software layer.

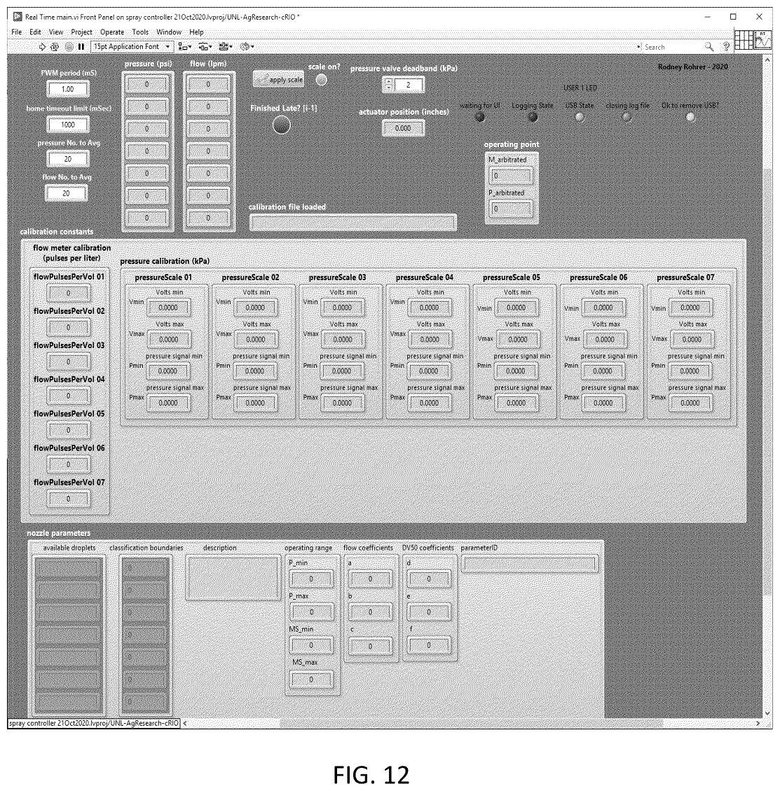

During initialization, the RT program read sensor calibration information from an xml file. The calibration values displayed on the RT front panel (FIG. 12) and were used to scale raw sensor values to engineering units. These data were sent to the UI to be displayed for the operator and was also saved to a log file. FIG. 12 shows Real Time layer front panel displaying constants read from calibration file and nozzle characteristics loaded from parameter file.

Table C shows an example of parameter file for a “green” (arbitrary moniker) nozzle tip.

| | | droplet | | | | |
|---|---|---|---|---|---|---|
| flow | DV50 | classification | | | | |
| polynomial | polynomial | boundaries | droplet | operating | parameter | |
| coefficients | coefficients | (Dv50 micron) | categories | range | file ID | description |
| 3.5099 | 653.3 | 0 | Medium (M) | 138 | G120720202301v3 | nozzle01 flow polynomial |
| 0.0078 | −0.4014 | 142 | Coarse (C) | 414 | | coefficents from SPL |
| −0.0046 | −0.3069 | 260 | Very Coarse (VC) | 400 | | |
| | | 376 | | 750 | | Dec2020 WCREC DV50 |
| | | 438 | | | | polynomial coefficients & |
| | | 522 | | | | droplet classification |
| | | 662 | | | | boundaries |

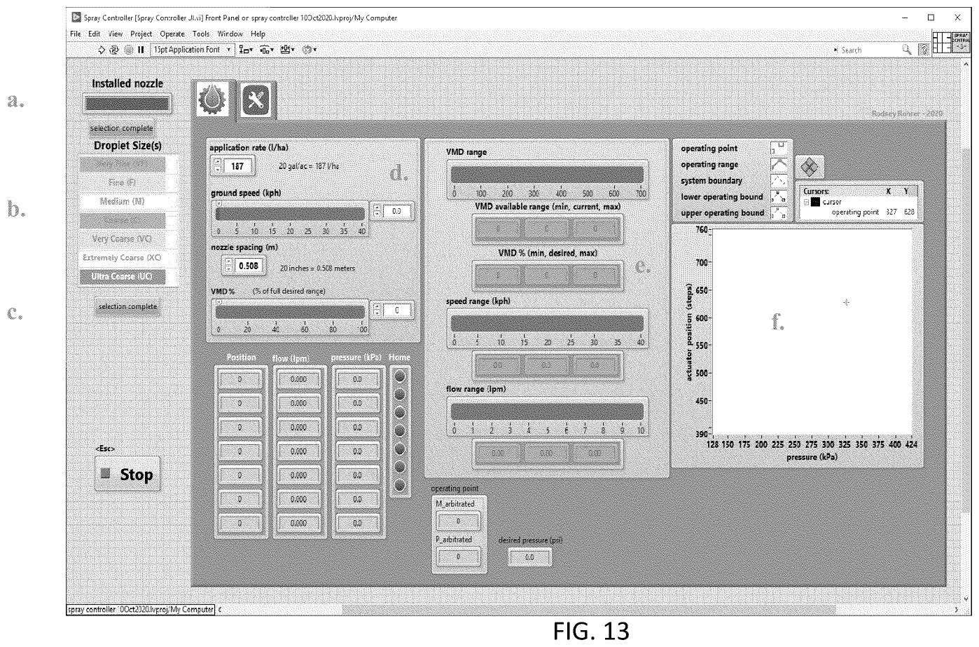

When the parameter file was read from the USB drive connected to the embedded controller, nozzle parameter information was stored in an array variable available to the UI and the algorithm embedded in the RT layer. The algorithm also required application rate, ground speed, nozzle spacing, and desired droplet size from operator inputs on the UI front panel. In addition to desired pressure and actuator position, the RT layer calculated the achievable minimum and maximum flow rate, ground speed, and droplet size which were sent to the UI for the operator's reference. This is shown in FIG. 13, which shows a User interface front panel control tab. a.) nozzle type selector, b.) droplet spectra selector, c.) selection complete button, d.) system controls, e.) system feedback, f.) graph of system model.

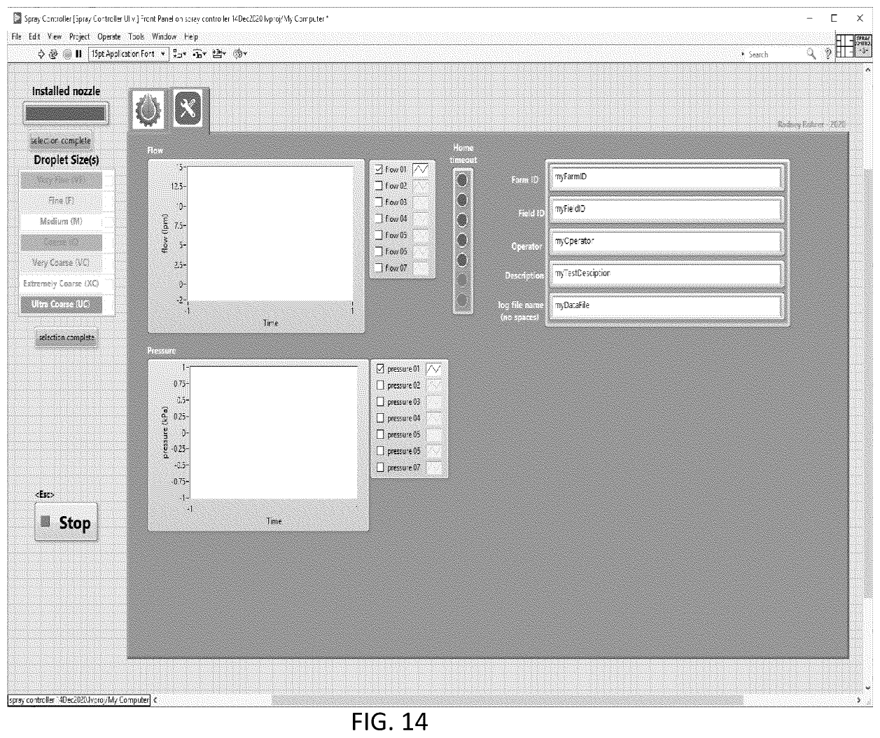

FIG. 14 shows a user set-up screen. Before starting the UI, the operator could enter a farm ID, field ID, operator name, description, and log file name on the front panel setup tab. The setup tab included home timeout indicators and graphs to monitor flow and pressure signals.

With reference again to FIG. 13, the UI software on the host PC would enter a standby mode where it awaited interaction from the operator to select the installed nozzle type (A) before loading the available droplet spectra for that nozzle (B). One or more of the available droplet spectra could be chosen before completing the selection (C) and starting the active control of the nozzles. To complete the setup, the operator also entered nozzle spacing (m) and desired application rate (l/ha) (D).

With the control system configured, the operator could adjust desired ground speed and droplet size (VMD %). This implementation of the system required the operator to indicate the intended steady-state ground speed. An alternative to such operator control is to receive an input from another system, such as an active ground speed sensor such as from GPS or radar, and the system can then automatically adjust the rate accordingly.

Droplet size control (VMD %) was configured as a percent of the range spanning the, one or more, droplet spectra selected by the operator at startup. For example, if the operator selected only medium droplet spectra, VMD % would be mapped across the range of medium droplet spectra (e.g., 260-376 μm) as 0%-100%. If medium and coarse droplet spectra were selected, VMD % would be mapped across the range of 260-438 μm.

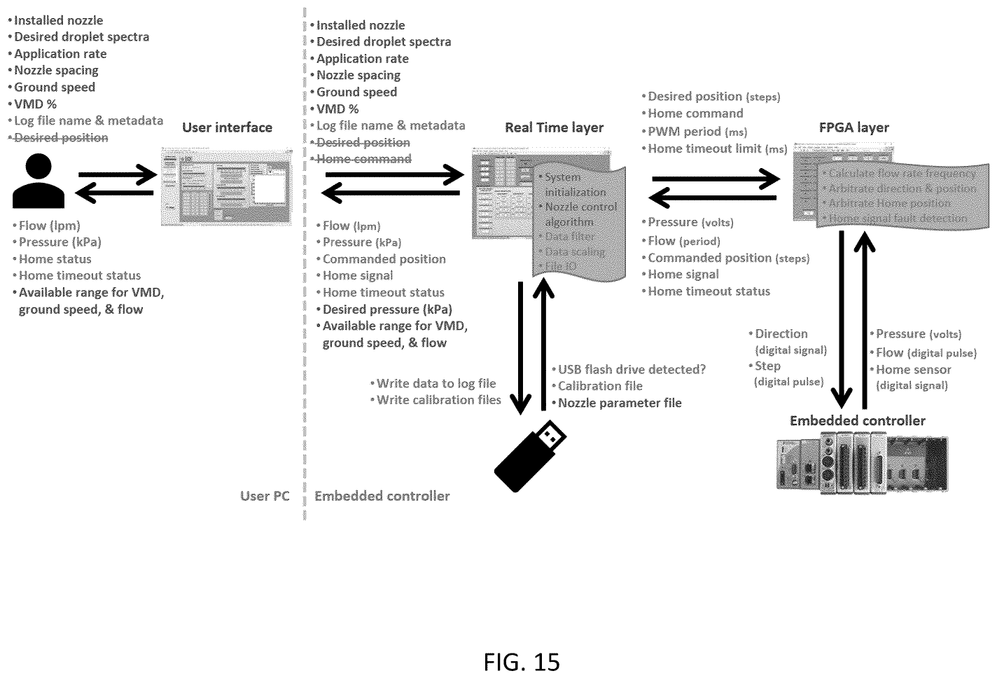

The range of available ground speed, flow, and droplet size (VMD % and μm) for the installed nozzle and selected droplet sizes were also displayed (E). The final feature on the front panel was a graph of the system model (F) showing the boundary of the system operating envelope, boundaries of the selected droplet spectra, and the current operating point (i.e., pressure and actuator position). Field program software interactions and logic described above is shown in FIG. 15. Most items are same as the service and calibration software of FIG. 6. are gray, new items for the field program software of FIG. 15 include installed nozzle profile, desired droplet size, application rate, nozzle spacing, ground speed, VMD %, desired pressure, available VMD range, groundspeed/flow, along with nozzle parameter file that is loaded from a memory.

The above testing provided good results using a linear math model. Higher order fits can be used. An example set of higher order fits is below:

| | polynomial degree | | | | | | | | | |
|---|---|---|---|---|---|---|---|---|---|---|
| | pressure | position | | | | | | | | |
| curve fit label | (x) | (y) | polynomial equation and coefficients | | | | | | R\hat{ }² | RMSE |
| expectedFlow11 | 1 | 1 | flow = p00 + p10*x + p01*y | | | | | | 0.9829 | 0.1052 |
| | | | p00 | p10 | p01 | | | | | |
| | | | 2.565 | 0.006208 | −0.00354 | | | | | |
| expectedFlow21 | 2 | 1 | flow = p00 + p10*x + p01*y + p20*x\hat{ }2 + p11*x*y | | | | | | 0.9985 | 0.03228 |
| | | | p00 | p10 | p01 | p20 | p11 | | | |
| | | | 1.367 | 0.01036 | −0.00139 | 5.89E−07 | −7.80E−06 | | | |
| expectedFlow12 | 1 | 2 | flow = p00 + p10*x + p01*y + p11*x*y + p02*y\hat{ }2 | | | | | | 0.9997 | 0.01535 |
| | | | p00 | p10 | p01 | p11 | p02 | | | |
| | | | 1.964 | 0.01069 | −0.00371 | −7.80E−06 | 2.02E−06 | | | |
| expectedFlow22 | 2 | 2 | flow = p00 + p10*x + p01*y + p20*x\hat{ }2 + p11*x*y + p02*y\hat{ }2 | | | | | | 0.9997 | 0.01481 |
| | | | p00 | p10 | p01 | p20 | p11 | p02 | | |
| | | | 2.002 | 0.01037 | −0.00371 | 5.83E−07 | −7.80E−06 | 2.02E−06 | | |

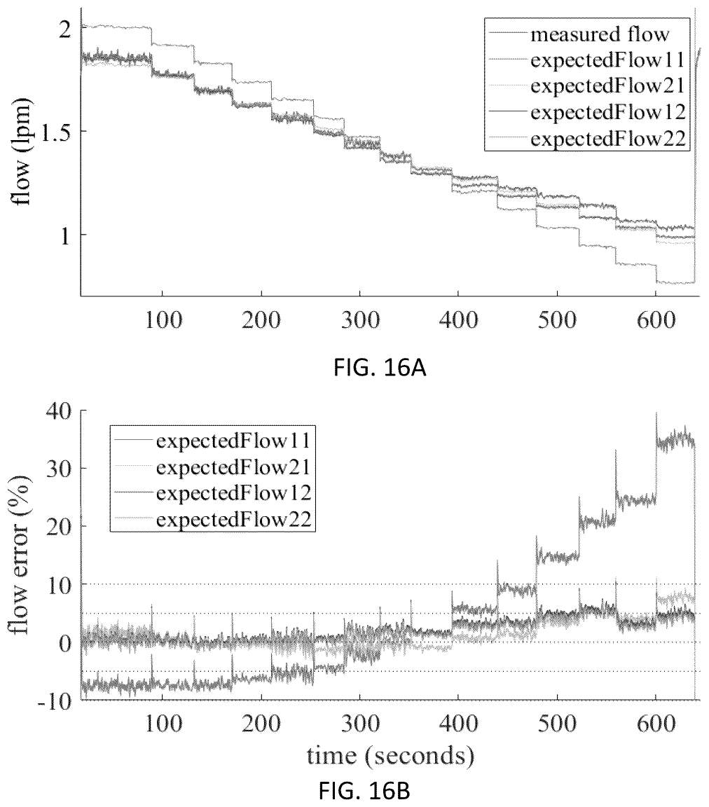

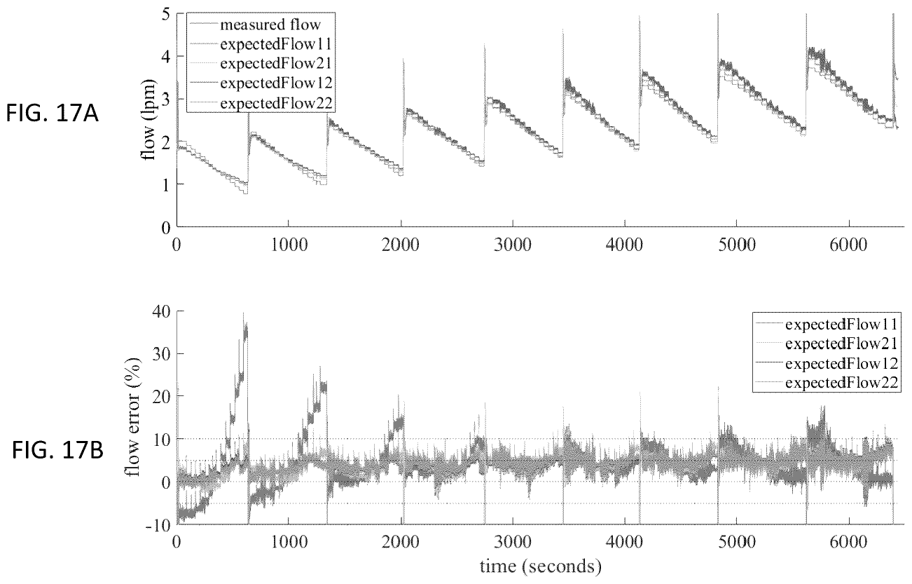

The curve fit polynomials were applied to the flow validation data for “blue” (arbitrary moniker) nozzle01 as shown in FIGS. 16A, 16B, 17A and 17B. Although the linear, first-order, curve fit (expectedFlow11) had an r-squared value of 0.98 there was still significant error at some operating points. The curve fit that was second-order on pressure and first-order on position (expectedFlow21) yielded a marginal increase in r-squared value but RMSE was an order of magnitude lower, resulting in a significant reduction in absolute error. The curve fits that were first-order on pressure and second-order on position (expectedFlow12) and second-order on pressure and position (expectedFlow22) showed similar, but incrementally better, results.

Although polynomial expectedFlow22 produced the best results of the polynomials that were evaluated, due to the two quadratic operators it would be the most difficult to implement in the nozzle control algorithm and most computationally intensive in software. This suggests that a polynomial that is first-order for pressure and second order for position (expectedFlow12) could be optimal, as this has lower error than the polynomial second-order on pressure and first order on position (expectedFlow21), and offers less complexity than the polynomial second-order on pressure and position (expectedFlow22).

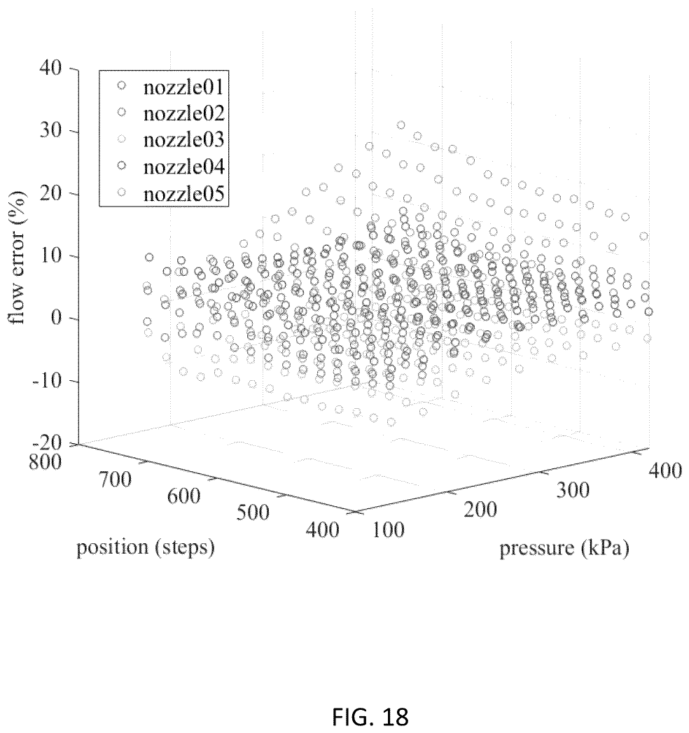

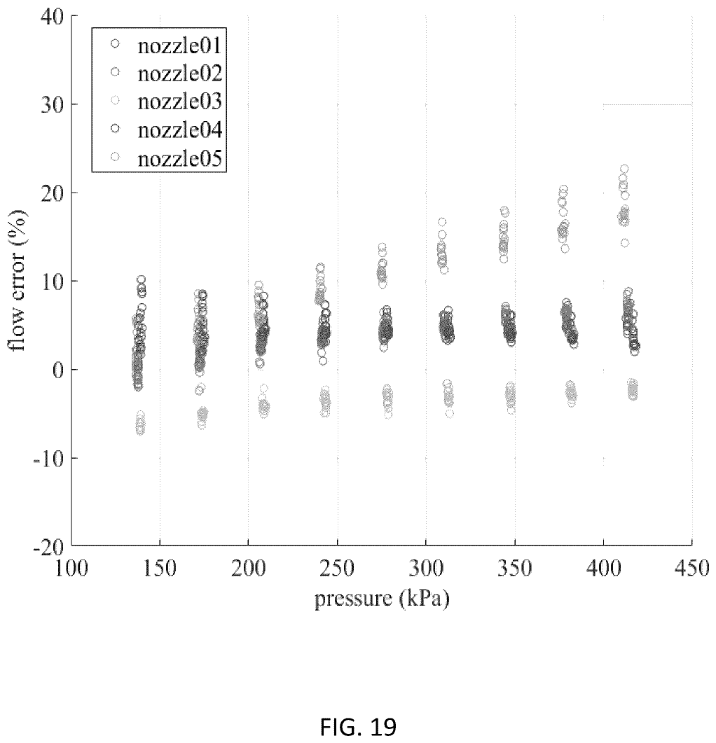

FIGS. 18 and 19 show flow error for polynomial expectedFlow12 applied to five blue nozzles using coefficients from nozzle01. Except for nozzle05, the error for all nozzles was reduced from −14%-40.9% to −7%-10% across the entire operating envelope.

### Weather Control System

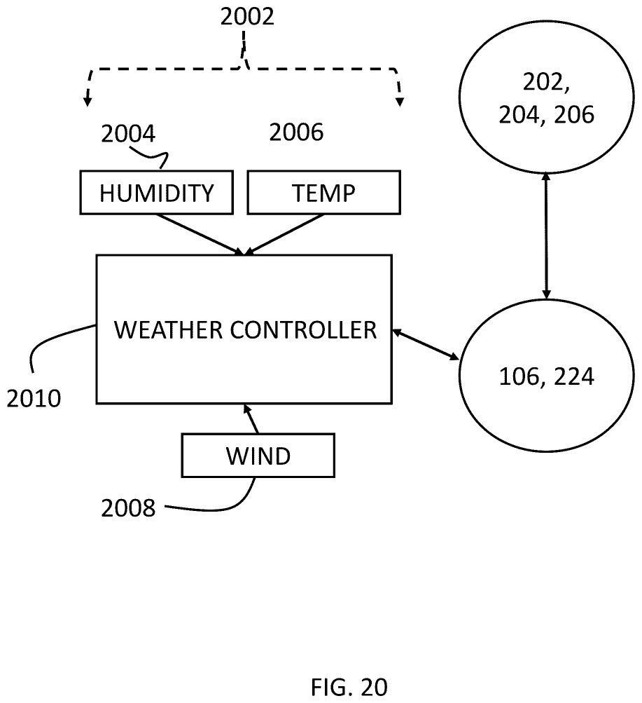

FIG. 20 shows a preferred weather control system 2002 to work the controller 106, 224 of FIG. 1 and FIGS. 2A-2B to respond to sensed weather conditions and adjust the requested nozzle flow rate and/or droplet size of the controller according to sensed weather conditions of one or more sensors, for example a humidity sensor 2004, a temperature sensor 2006, and a wind sensor 2008. While the sensors are shown as being separate, a single multi-sensor device can be used to report humidity, temperature, wind speed and direction, and other parameters that affect the drift distance of a droplet emitted from a nozzle. A weather controller 2010 monitors the sensors and provides adjustments to the controller 106, 224 of FIG. 1 and FIGS. 2A-2B to respond to sensed weather conditions and adjust the requested nozzle flow rate and/or droplet size.

Experiments have determined preferred operations for the weather controller 2010. These operations and experiments will now be discussed.

Experiments used an anemometer to record real time data to calculate the drift data. The anemometer (YOUNG Model 86000 2D Ultrasonic) provided wind speed and wind direction data and could also record relative humidity and temperature to further increase real time environmental data. The testing procedures used a desired range of 0-10 mph based upon average spring windspeed of 11 mph in Nebraska.

Weather controller code included code to digitize two known equations for a drift distance and drift evaporation distance. The variables can be rearranged for the use in the preferred weather controller such that a drift distance can be set beforehand as a target distance. This allows the controller to calculate the required droplet size to reach specified distance, while monitoring its required flow and pressure outputs simultaneously. This is shown in the following rearrangement, where the equation for droplet size can be used by the weather controller 2002:

$$Drift Distance = 393.9 ⋆ \frac{{H}^{0.45} ⋆ {Ws}_{x}^{0.35} ⋆ {T}^{- 0.04}}{{D}^{0.84} ⋆ {Vi}^{0.05} ⋆ {RH}^{- 0.24}} - 3.67$$

$${Distance}_{evap} = 0.1855 ⋆ \frac{{Ws}_{x}^{0.82} ⋆ {H}^{0.18} ⋆ {D}^{1.15} ⋆ {RH}^{0.34}}{{T}^{0.58} ⋆ {Vi}^{0.05}} - 2.97$$

$$Droplet size = \sqrt[\text{.84}]{\frac{393.9 ⋆ {H}^{\text{.45}} ⋆ {WS}^{\text{.35}} ⋆ {T}^{- \text{.04}}}{( Dd + 3.67 ) ⋆ {Vi}^{\text{.05}} ⋆ {Rh}^{- \text{.24}}}}$$

where H=Nozzle Height from Target (meters), T=temperature (Celsius), D=droplet size (μm), Vi=Droplet Initial Velocity from Nozzle (m/s) and Rh=Relative Humidity (%).

Control should be conducted with a goal of having the droplet size set to its smallest size to avoid being evaporated and to keep error and mismanagement of liquid at a minimum and efficiency at a maximum. By setting a designated drift distance, the code can be rearranged to equate to a desired Dv10 size (Dv10 represents the 10th percentile droplet size from a cumulative distribution of droplets measured for a given nozzle/pressure), allowing environmental information to affect the droplet size directly being calculated. For this test, a desired drift distance of 6 meters (20 feet) was set. A new desired Dv10 droplet size percent can be determined rather than declaring it an entry constant variable of its own. Using the 20 ft required drift distance, the droplet size was placed below most of the minimum range Dv10% requirements. This was beneficial as the range does not allow the droplet size to decrease below a certain range, resulting in the drift distance not being at risk of evaporation. As the wind speed and humidity increase, the minimum required DV10 will increase due to the consistent required drift range until it rises above the parameters allowable in the range provided by the entered nozzle and spectra. Current measurements do not increase the droplet size beyond 250 microns on average, ensuring that the droplet ranges were within the allowable wind speed farmers would irrigate in before the wind grows too strong.

A software module subVI collects information input by a user from the nozzle system controller 106, 224 and modifies settings as calculated by the weather controller (in real time) and returns modified settings to the nozzle system controller 106, 204, which can use the modified settings for control and provide/display the settings to a user. Real time updates can occur, for example every second, or over a longer period, such as every minute or few minutes.

An experimental weather control software module used a basic write to Excel® function for .csv files. This was used to track collected versus predicted data for pressure, flow, nozzle position, and volumetric mean diameter. The data were organized and presented in columns to calculate error between predicted versus actual. The timing was set to append information to the array every second to show the speed that a parameter can be altered and have the module update the code to correct the changes.

The following is a table of reference mean droplet diameters collected in an experiment.

Droplet Spectra Classification Boundaries

| | mean diameter (μm) | | | | | | | | |
|---|---|---|---|---|---|---|---|---|---|
| | D_{v0.1} | | | D_{v0.5} | | | D_{v0.9} | | |
| | | std. | | | std. | | | std. | |
| categories⁺ | avg | dev. | sum | avg | dev. | sum | avg | dev. | sum |
| VF/F | 65 | 0.3 | 65 | 141 | 0.4 | 141 | 239 | 1.5 | 241 |
| F/M | 120 | 1.1 | 121 | 261 | 1.0 | 262 | 424 | 1.5 | 425 |
| M/C | 177 | 2.3 | 180 | 377 | 3.1 | 380 | 587 | 3.2 | 590 |
| C/VC | 207 | 0.4 | 207 | 446 | 0.7 | 446 | 747 | 0.9 | 748 |
| VC/XC | 255 | 0.5 | 256 | 542 | 0.8 | 542 | 856 | 0.3 | 856 |
| XC/UC | 339 | 0.5 | 340 | 690 | 1.5 | 692 | 1082 | 3.7 | 1086 |
| very fine | M = medium | | | VC= | y coarse | | UC = ultra coarse | | |
| F = fine | C = cos | arse | | XC= | xtremely | rrse | | | |

The main controller 106, 224 considers application rate, ground speed, desired Dv10%, Droplet parameters and spectra information were collected in real time and run through multiple sets of equations to calculate the available DV10 range in minimum and maximum, the current flow rate, and the Dv high and low values. These values were used to determine the desired nozzle position in steps and the arbitrated pressure value using the derived DV10 and coefficient values depending on the spectra. Once arbitrated, the values were stored and recycled into inputs to further refine the values until the output pressure, DV10, and steps were equal to the input setting.

A process for determining necessary pressure and nozzle step takes in values such as flow rate, ground speed, and measured DV10% into the formula to determine minimum and maximum allowable steps from the operating range from the nozzle parameters along with the flow and DV10 coefficient values. Next, the selected droplet spectra measured the Dv10 high and low values necessary for the set equations before ending with reading in previous values of the arbitrated values and the maximum and minimum range of the pressure and steps (set to equal zero during the first iteration of equations). The code checks if the pressure, DV10, and step range maximum are greater than the minimum for determining the arbitrated values. Once derived, it will next determine if the desired pressure resulting from the DV10 was greater than the pressure maximum or less than the minimum. If the DV10 remains within the threshold range, then the pressure equals the desired DV10 pressure. The same formula occurs for the nozzle steps, however the arbitrated pressure value for the steps uses a measurement of a linear equation.

$$Q = \frac{appRate}{10000} ⋆ speed ⋆ \frac{1000}{60} ⋆ nozzleSpacing ( flow rate )$$

$$Q = Flow rate$$

$$slope = \frac{{M}_{DVHighNozzleLim} - {M}_{DvLowNozzleLim} )}{( {P}_{DvHighNozzleLim} - {P}_{DvLowNozzleLim} )} ( Nozzle Step Slope )$$

$$intercept = {M}_{DvLowNozzleLim} - slope ⋆ {P}_{DvLowNozzleLim} ( Nozzle Step Intercept )$$

$${M}_{{P}_{arbitrated}} = slope ⋆ {P}_{arbitrated} + intercept ( Arbitrated Nozzle Steps w / Pressure )$$

$$M\_P \_arbitrated = arbitrated nozzle step pressure$$

$$Dv {10}_{arbitrated} = d + e ⋆ {P}_{arbitrated} + f ⋆ {M}_{arbitrated} ( Arbitrated Droplet Size )$$

Seven total tests were taken at different humidities, and their results were placed into an Excel graph to easily monitor changes. A difference between desired and arbitrated droplet sizes is tracked versus the pressure changes, the environmental factors including the wind speed, humidity, flow rate, and temperature, which now directly affect the changes in droplet sizes. The finished droplets were then compared to current nozzles to monitor differences in size between the two.

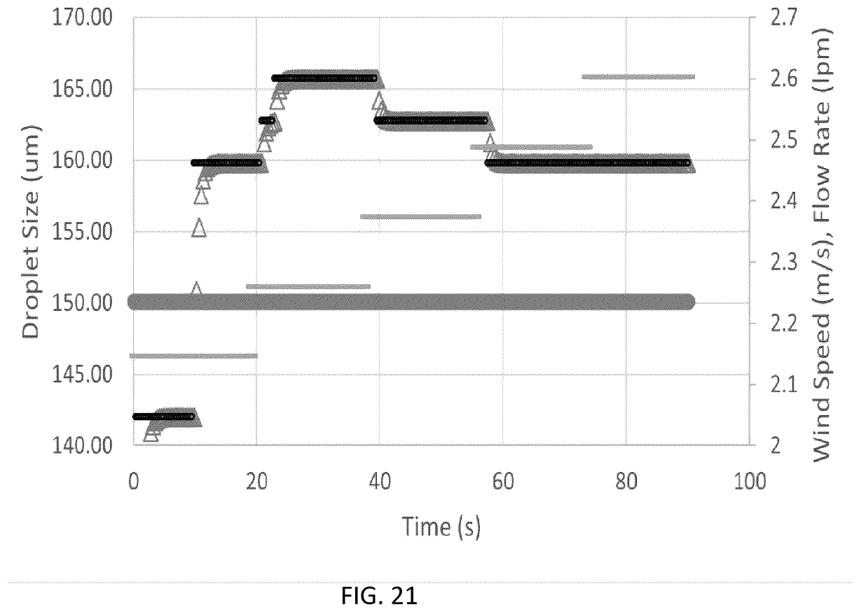

FIG. 21 shows an example of Desired vs. Arbitrated Dv10 Droplet Size taken at a 30% Relative Humidity without changing wind speed. The following table shows response time and steady state error of arbitrated and desired droplet sizes under a 30% humidity with no change in wind.

| Desired Dv10 | Arbitrated Dv10 | | |
|---|---|---|---|
| Size | Size | Response Time | Ess(%) |
| 160 | 142 | 1.412 | 0.107 |
| 163 | 161 | 0.353 | 0.270 |
| 166 | 164 | 0.353 | 0.130 |

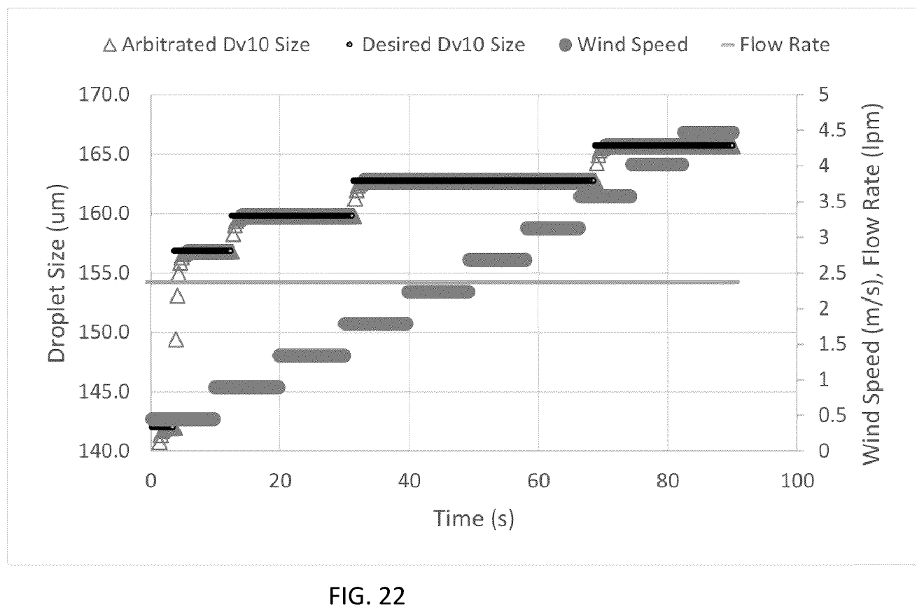

FIG. 22 shows an example of Desired vs. Arbitrated Dv10 Droplet Size taken at a 30% Relative Humidity without changing flow. The following table shows Recorded Response Time and Steady State Error of Arbitrated and Desired droplet sizes under a 30% Relative Humidity with no change in flow.

| Desired Dv10 | Arbitrated Dv10 | | |
|---|---|---|---|
| Size | Size | Response Time | Ess(%) |
| 157 | 149 | 0.649 | 0.091 |
| 160 | 158 | 0.216 | 0.132 |
| 163 | 161 | 0.216 | 0.130 |
| 166 | 164 | 0.216 | 0.128 |

A smallest droplet size under 10% relative humidity testing began at a VMD size of 147.92 microns and the maximum reached 156.8 microns. Initial measurements indicate that as the wind speed increases, the rate that the volumetric mean diameter droplet size decreases in a concave down pattern. The changes shown by the droplets appear to be standard across all changes in increasing sizes, with each increase averaging around three microns increased in the desired size.

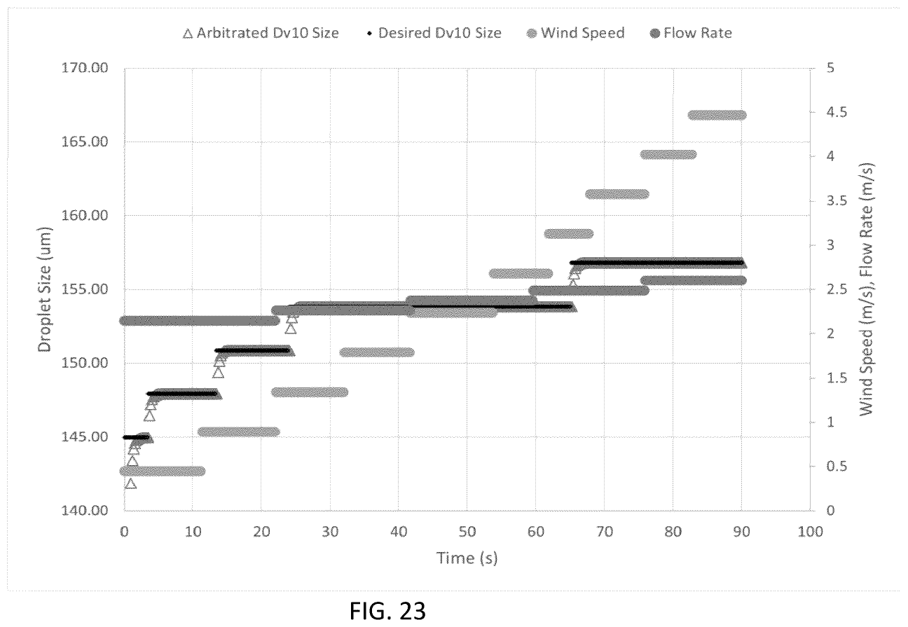

FIG. 23 shows Desired vs. Arbitrated Dv10 Droplet Size taken at a 10% Relative Humidity with changing Wind Speed and Flow values. The following table shows Desired vs. Arbitrated Dv10 Droplet Size taken at a 10% Relative Humidity with changing Wind Speed and Flow values.

| Desired Dv10 | Arbitrated Dv10 | | |
|---|---|---|---|
| Size | size | Response Time | Ess(%) |
| 147.92 | 144.96 | 0.38 | 0.133 |
| 150.88 | 149.4 | 0.38 | 0.140 |
| 153.84 | 150.88 | 0.38 | 0.137 |
| 156.8 | 155.32 | 0.38 | 0.135 |

Another test recorded the results at a relative humidity of 60% while maintaining the wind speed increase of 0-10 miles per hour and a flow rate increase of 17-23 gallons per minute simultaneously over the minute and a half measurement.

Final results measuring desired and actual pressure, flow, and wind speed over changing between columns far more steadily than the previous 40% test. With a size range of 159.76 to 165.68 μm, the erratic nature followed by a steady state could indicate that the wind speed heavily affects the changes on 40%, but the humidity in 50% places the size high enough in the range that a change in wind speed would not overly affect the end range result.

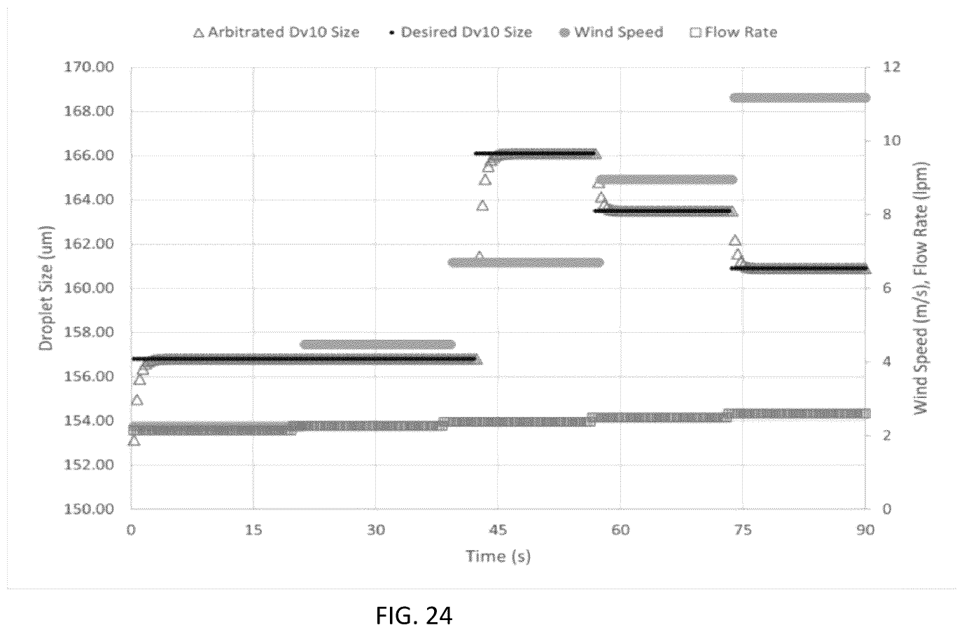

FIG. 24 shows Desired vs. Arbitrated Dv10 Droplet Size taken at a 60% Relative Humidity with higher Wind Speed and Flow values than allowed by standard irrigation practices. The following table shows Recorded Response Time and Steady State Error of Arbitrated and Desired droplet size under a 60% Relative Humidity while using heavily abnormal Wind Speed as a stress test.

| Desired Dv10 | Arbitrated Dv10 | | |
|---|---|---|---|
| Size | Size | Response Time | Ess(%) |
| 166 | 161 | 1.06 | 0.107 |
| 163 | 165 | 0.356 | −0.122 |
| 161 | 162 | 0.356 | −0.124 |

While preferred embodiments have been described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A variable-orifice spray nozzle system comprising:
at least one variable-orifice spray nozzle including a nozzle body having a flexible nozzle orifice opening and a mechanism that physically changes the size and shape of the flexible nozzle orifice opening, an actuator to set and change the position of the orifice control mechanism, and a mount to attach to a spray boom, wherein the actuator has a home position;
a pressure sensor to sense fluid pressure delivered to the nozzle body; and
a controller to control the actuator to set a requested nozzle flow rate and/or droplet size based upon data from the pressure sensor via positioning of the actuator, wherein the controller tracks the actuator position relative to its home position via open loop control.

2. The variable-orifice spray nozzle system of claim 1, comprising a home position sensor to sense the home position of the actuator.

3. The variable-orifice spray nozzle system of claim 1 having no flow sensor.

4. The variable-orifice spray nozzle system of claim 1, wherein the actuator comprises a stepper motor, and the controller tracks the actuator position by counting motor steps relative to the home position.

5. The variable-orifice spray nozzle system of claim 4, wherein the controller runs a loop control, and with each loop checks status of the home position sensor and if the status indicates that the actuator is not in the home position, calculates position, set directions, generates a pulse for each step, and counts ascending or descending steps to maintain a record of actual position.

6. The variable-orifice spray nozzle system of claim 1, wherein the nozzle body comprises diaphragm to prevent fluid flow toward the actuator.

7. The variable-orifice spray nozzle system of claim 6, wherein the nozzle body comprises a weep hole between the diaphragm and the actuator.

8. The variable-orifice spray nozzle system of claim 1, wherein the controller maintains continuous power to the actuator during periods of non-movement of the actuator.

9. The variable-orifice spray nozzle system of claim 8, wherein the nozzle body comprises a heat sink for the actuator.

10. The variable-orifice spray nozzle system of claim 1, wherein the controller provides digital outputs of direction, step and home position to the actuator.

11. The variable-orifice spray nozzle system of claim 10, wherein the controller asserts the home position signal upon startup.

12. The variable-orifice spray nozzle system of claim 11, wherein the controller controls fluid pressure delivered to the nozzle body.

13. The variable-orifice spray nozzle system of claim 1, wherein the controller receives independent specification of flow rate and droplet size and independently controls flow rate and droplet size by setting effective orifice size and the fluid pressure delivered to the nozzle body.

14. The variable-orifice spray nozzle system of claim 1, wherein the controller sets effective orifice size and system pressure according to
$$P = \frac{( Q - a ) ⋆ f + ( d - VMD ) ⋆ c}{b ⋆ f - c ⋆ e} \qquad Equation 1.4$$
$$M = \frac{( VMD - d ) ⋆ b + ( a - Q ) ⋆ e}{b ⋆ f - c ⋆ e} \qquad Equation 1.5$$
Where, Q=flow rate (lpm)
VMD=droplet volume mean diameter (μm)
P=pressure (kPa)
M=effective orifice size; and
a, b, c, d, e, f=polynomial coefficients, the polynomial coefficients being set according to regression analysis on respective nozzle performance data.

15. The variable-orifice spray nozzle system of claim 14, wherein droplet size (VMD), is specified directly by an operator input or input from another system.

16. The variable-orifice spray nozzle system of claim 15, wherein the operator input or input from another system comprises one or more of wind speed, relative humidity, application rate (l/ha), desired steady-state ground speed, plant or weed species, and a geospatial prescription map

17. The variable-orifice spray nozzle system of claim 14, wherein with application rate, nozzle spacing, and ground speed known, the controller determines required nozzle flow rate from equation 1.3:
$$Q = rate ⋆ \frac{speed}{600} ⋆ nozzle spacing \qquad Equation 1.3$$
rate=application rate (l/ha)
speed=ground speed (kph)
nozzle spacing (m).

18. The variable-orifice spray nozzle system of claim 14, wherein the polynomial coefficients are set according to:

| | | polynomial coefficients | | | | |
|---|---|---|---|---|---|---|
| | | a | b | c | R² | RMSE |
| blue | nozzle01 | 2.5647 | 0.0062 | −0.0035 | 0.983 | 0.105 |
| | nozzle02 | 2.5526 | 0.0065 | −0.0036 | 0.984 | 0.105 |
| | nozzle03 | 2.3944 | 0.0057 | −0.0033 | 0.979 | 0.108 |
| | nozzle04 | 2.6312 | 0.0059 | −0.0034 | 0.984 | 0.097 |
| | nozzle05 | 2.4283 | 0.0074 | −0.0035 | 0.985 | 0.108 |
| | mean | 2.5136 | 0.0064 | −0.0035 | 0.984 | 0.104 |
| green | nozzle01 | 3.5099 | 0.0078 | −0.0046 | 0.987 | 0.119 |
| | nozzle02 | 3.4464 | 0.0074 | −0.0045 | 0.987 | 0.112 |
| | nozzle03 | 3.3714 | 0.0077 | −0.0045 | 0.987 | 0.114 |
| | nozzle04 | 3.4781 | 0.0079 | −0.0045 | 0.984 | 0.130 |
| | nozzle05 | 3.5650 | 0.0081 | −0.0045 | 0.987 | 0.120 |
| | mean | 3.4741 | 0.0078 | −0.0045 | 0.987 | 0.118 |

19. The variable-orifice spray nozzle system of claim 14, wherein the polynomial coefficients are set according to linear modeling to determine the coefficients based upon testing or modeling of the at least one variable-orifice spray nozzle.

20. The variable-orifice spray nozzle system of claim 14, wherein the polynomial coefficients are set according to first-order for pressure and second order for position modeling to determine the coefficients based upon testing or modeling of the at least one variable-orifice spray nozzle.

21. An agricultural spray system, comprising the system of claim 1, and a plurality of the at least one variable-orifice spray nozzles mounted spaced apart on a spray boom.

22. A method for controlling a variable-orifice spray nozzle system having a plurality of variable-orifice spray nozzles, the method comprising:
upon startup, sending a control signal to the plurality of variable-orifice spray nozzles to set an actuator that sets and changes the position of an orifice control mechanism in each nozzle to a home position;
determining a position of the actuator and a fluid pressure level to achieve a desired nozzle flow rate and droplet size;
setting the fluid pressure level;
controlling the actuator to set the position via open loop control that controller commands step movement and direction of the actuator and tracks the actuator position by counting motor steps relative to the home position.

23. An agricultural spray system, comprising:
a plurality of variable-orifice spray nozzles spaced apart on a spray boom, each of the plurality of variable-orifice spray nozzles including a nozzle body having a flexible nozzle orifice opening and a mechanism that physically changes the size and shape of the flexible nozzle orifice opening, an actuator to set and change the position of the orifice control mechanism, and a mount to attach to a spray boom, wherein the actuator has a home position;
a pressure sensor to sense fluid pressure delivered to the nozzle body;
a controller to control the actuator to set a requested nozzle flow rate and/or droplet size based upon data from the pressure sensor via positioning of the actuator, wherein the controller tracks the actuator position relative to its home position via open loop control; and
a weather control system including one or more sensors, the weather control system being configured to adjust the requested nozzle flow rate and/or droplet size of the controller according to sensed weather conditions of the one or more sensors.

24. The agricultural spray system of claim 23, wherein the one or more sensors comprises wind speed, wind direction and humidity sensors.

25. The agricultural spray system of claim 24, wherein the weather control system determines a drift evaporation distance and adjusts droplet size to meet a target distance of droplet travel.

26. The agricultural spray system of claim 24, wherein the weather control system and the controller determine an adjusted droplet size as a function of wind speed, temperature, target distance of droplet travel, droplet initial velocity and relative humidity.

27. The agricultural spray system of claim 26, wherein the control system and the controller determine a smallest droplet size needed to avoid evaporation.
